(19) United States
(12) Patent Application Publication
(10) Pub. No.: US 2013/0207596 A1
(43) Pub. Date: Aug. 15, 2013

(54) ELECTROCHEMICAL ENERGY CONVERTER DEVICE WITH A CELL HOUSING, A BATTERY WITH AT LEAST TWO OF SAID ELECTROCHEMICAL ENERGY CONVERTER DEVICES, AND A METHOD FOR THE MANUFACTURE OF AN ELECTROCHEMICAL ENERGY CONVERTER DEVICE

(71) Applicant: LI-TEC BATTERY GMBH, (US)

(72) Inventors: Marco Zichner, Dresden (DE); Tim Schaefer, Harztor (DE); Werner Hufenbach, Dresden (DE)

(73) Assignee: LI-TEC BATTERY GMBH, Kamenz (DE)

(21) Appl. No.: 13/750,002

(22) Filed: Jan. 25, 2013

Related U.S. Application Data
(60) Provisional application No. 61/590,825, filed on Jan. 26, 2012.

(30) Foreign Application Priority Data
Jan. 26, 2012 (DE) 10 2012 001 440.6

(51) Int. Cl. H01M 2/02

(52) U.S. Cl. CPC H01M 2/024
USPC 320/107; 429/163; 429/178; 429/90; 429/61; 429/82; 429/72; 429/120; 429/156; 29/623.1

(57) ABSTRACT

An electrochemical energy converter device (1) with at least one in particular rechargeable electrode assembly (2), which is provided so as to make electrical energy available, at least temporarily, in particular to a consumer load, which has at least two electrodes (3, 3a) of differing polarity, with at least one current conducting device (4, 4a), which is provided to be electrically connected, preferably materially connected, with one of the electrodes (3, 3a) of the electrode assembly (2), with a cell housing (5) with a first housing part (6), wherein the first housing part (6) is provided so as to enclose the electrode assembly (2) at least in certain sections.

The present invention concerns an electrochemical energy converter device, hereinafter also referred to as a converter cell, with a cell housing, a battery, with at least two of the said electrochemical energy converter devices, and a method for the manufacture of an electrochemical energy converter device. The invention is described in the context of lithium-ion batteries for the supply of motor vehicle drives. It is pointed out that the invention can also find application independently of the chemistry of the converter cell, or of the type of construction of the battery, or independently of the type of drive supplied.

From the prior art, batteries with a plurality of converter cells for the supply of motor vehicle drives known. Conventional converter cells have an electrode assembly with at least two electrodes of differing polarity and a separator. The separator separates, i.e. spaces apart, the electrodes of differing polarity. Furthermore, conventional converter cells have a cell housing which surrounds the electrode assembly, at least in certain sections. Furthermore conventional converter cells have at least two current conducting devices, which are each electrically connected with an electrode of the electrode assembly.

The high level of complexity in the manufacture of some types of converter cells is sometimes found to be problematic.

It is an object of the invention to provide a converter cell that can be manufactured with a less complexity and/or cost.

The object is achieved by means of an electrochemical energy converter device in accordance with claim 1. Claim 13 describes a battery with at least two electrochemical energy converter devices according to the invention. The object is also achieved by means of a manufacturing method for an electrochemical energy converter device in accordance with claim 14. Preferred developments of the invention are the subjects of the dependent claims.

An electrochemical energy converter device according to the invention, hereinafter also referred to as a converter cell, has at least one, in particular rechargeable, electrode assembly. The at least one electrode assembly is provided so as to make electrical energy available, in particular to a consumer load, at least temporarily. The electrode assembly has at least two electrodes of differing polarity. The converter cell has one, two, or a plurality of current conducting devices, wherein at least one or a plurality of the said current conducting devices are provided so as to be electrically connected, preferably materially connected, with one of the electrodes of the electrode assembly. The converter cell has a cell housing with at least one, in particular a first, housing part, wherein the cell housing is provided so as to enclose the electrode assembly, at least in certain sections. The first housing part has at least one functional device, which is provided so as to support the output of energy from the electrode assembly, in particular to a consumer load. The functional device is operationally connected with the electrode assembly, in particular for the purpose of receiving energy. The first housing part has at least one first load-bearing element, which is provided so as to demarcate the at least one functional device from the surroundings of the converter cell. The first load-bearing element serves in particular the purpose of supporting the at least one functional device, i.e. in particular to counter any undesirable movement of the at least one functional device relative to the converter cell. The first load-bearing element serves in particular the purpose of protecting the at least one functional device from damaging environmental influences.

The at least one electrode assembly is preferably provided so as to convert chemical energy into electrical energy, at least temporarily. The at least one electrode assembly is preferably provided so as to convert electrical energy, in particular supplied electrical energy, into chemical energy, at least temporarily.

In a design of the first housing part according to the invention, the functional device undertakes a plurality of functions in particular concerning the operation of the converter cell, i.e. of the electrode assembly, which functions are fulfilled by discrete components in converter cell designs of known art. A plurality of discrete components, i.e. functional elements, in the at least one functional device are in particular consolidated into a single functional module. Thus for the manufacture of the converter cell according to the invention, fewer modules are required, as a result of which the level of complexity in the manufacture and assembly is reduced. In this manner the fundamental object is achieved.

Furthermore, the converter cell according to the invention offers the advantage of increased durability, in that the first load-bearing element protects the functional device that is located underneath it from mechanical damage, in particular damage caused by a foreign body impacting onto the cell housing. Furthermore the converter cell according to the invention offers the advantage of increased durability, in that the first load-bearing element improves the cohesiveness of the functional device, in particular in the event of accelerations or vibrations occurring during the operation of the converter cell.

In the context of the present invention, an electrode assembly is understood to be a device which in particular serves to provide electrical energy.

The electrode assembly has at least two electrodes of differing polarity. The said electrodes of differing polarity are spaced apart by a separator which can conduct ions, but not electrons. The electrode assembly is preferably designed to have an essentially quadrilateral shape. The electrode assembly is preferably connected, in particular materially connected, with two of the said current conducting devices of differing polarity; these serve the purpose of at least indirect electrical connection with at least one adjacent electrode assembly, and/or, at least indirectly, the electrical connection with the consumer load.

At least one of the said electrodes preferably has an in particular metallic collector film and also an active mass. The active mass is applied onto at least one side of the collector film. During the charging or discharging processes of the electrode assembly, electrons are exchanged between the collector film and the active mass. Preferably at least one collector tab is connected, in particular materially connected, with the collector film. It is particularly preferable for a plurality of collector tabs to be connected, in particular materially connected, with the collector film. The said configuration offers the advantage that the current per collector tab is reduced.

At least one of the said electrodes preferably has an in particular metallic collector film and also two active masses of differing polarity; the latter are arranged on different surfaces of the collector film and are spaced apart by the collector film. The term “bi-cell” is also commonly used for the said arrangement of active masses. During the charging or discharging processes of the electrode assembly, electrons are exchanged between the collector film and the active mass. At least one collector tab is preferably connected, in particular materially connected, with the collector film. It is particularly preferable for a plurality of collector tabs to be connected, in particular materially connected, with the collector film. The said configuration offers the advantage that the number of electrons that flow through a collector tab per unit time is reduced.

Two electrodes of differing polarity are spaced apart in the electrode assembly by a separator. The separator is permeable to ions, but not to electrons. The separator preferably contains at least one part of the electrolyte, i.e. the conducting salt. The electrolyte is preferably essentially formed without a fluid component, in particular after the closure of the converter cell. The conducting salt preferably includes lithium. It is particularly preferable for lithium ions to be stored, i.e. intercalated, in the negative electrode during the charging process, and to be released once again during the discharging process.

The electrode assembly is preferably configured so as to convert supplied electrical energy into chemical energy, and to store it as chemical energy. The electrode assembly is preferably configured in particular so as to convert stored chemical energy into electrical energy, before the electrode assembly makes the said electrical energy available to a consumer load. This is then also referred to as a rechargeable electrode assembly. It is particularly preferable for lithium ions to be stored, i.e. intercalated, in the negative electrode during the charging process, and to be released once again during the discharging process.

In accordance with a first preferred configuration, the electrode assembly is designed as an electrode coil, in particular as an essentially cylindrical electrode coil. The said electrode assembly is preferably rechargeable. The said configuration offers the advantage of simpler manufacturability, in particular in that strip-form electrodes can be processed. The said configuration offers the advantage that the nominal charge capacity, specified, for example, in ampere-hours [Ah] or watt-hours [Wh], less often in coulombs [C], can be increased in a simple manner by means of further windings. The electrode assembly is preferably designed as a flat electrode coil. The said configuration offers the advantage that it can be arranged in a space-saving manner alongside another flat electrode coil, in particular within a battery.

In accordance with a further preferred configuration, the electrode assembly is designed as an electrode stack of an essentially quadrilateral shape. The said electrode assembly is preferably rechargeable. The electrode stack has a predetermined sequence of stacked sheets, wherein each pair of electrode sheets of differing polarity is separated by a separator. Each electrode sheet is preferably connected, in particular materially connected, with a current conducting device; it is particular preferred for the electrode sheet to be designed integrally with the current conducting device. Electrode sheets of the same polarity are preferably electrically connected to each other in particular via a common current conducting device. The said configuration offers the advantage that the nominal charge capacity, specified, for example, in ampere-hours [Ah] or watt-hours [Wh], less often in coulombs [C], can be increased in a simple manner by the insertion of further electrode sheets. It is particularly preferable for at least two separator sheets to be connected to each other, and to enclose a bounding edge of an electrode sheet. Such an electrode assembly with a single separator, in particular one with a meandering shape, is described in WO 2011/020545. The said configuration offers the advantage that a parasitic current, originating from the said bounding edge to an electrode sheet of another polarity, is countered.

In accordance with a third preferred configuration, the electrode assembly is designed to provide: electrical energy involving at least one continuously supplied fuel and one oxidising agent, in what follows called the process fluid, its chemical reaction to form an educt, in particular supported by at least one catalyst, and output of the educt. In what follows, the electrode assembly, in accordance with the said preferred configuration, is also called a converter assembly. The converter assembly is designed as an electrode stack that is essentially quadrilateral in shape, and has at least two electrodes, in particular of sheet form, of differing polarity. At least the first electrode is preferably coated with a catalyst, at least in certain sections. The electrodes are spaced apart, preferably by a separator, i.e. a membrane, which is permeable to ions, but not to electrons. Furthermore the energy converter has two fluid supply devices, each of which are arranged adjacent to the electrodes of differing polarity, and are provided so as to supply the process fluid to the electrodes. At least one of the fluid supply devices is preferably provided so as to remove the educt. The converter assembly has at least one of the following sequences: a fluid supply device for the fuel—an electrode of first polarity—a membrane—an electrode of second polarity—a fluid supply device for the oxidising agent, in particular also for the educt. A plurality of the said sequences are preferably electrically connected in series to provide an increased electrical voltage. During operation of the energy converter, the fuel is supplied to the first electrode, in particular as a flow of fluid through passages of the first fluid supply device. On the first electrode the fuel is ionised with the release of electrons. The electrons are discharged via the first electrode, in particular via one of the current conducting devices, in particular in the direction of an electrical consumer load or an adjacent converter cell. The ionised fuel passes through the membrane that is permeable to ions, and to the second electrode. The oxidising agent is supplied to the second electrode, in particular as a flow of fluid through passages of the second fluid supply device. At the second electrode the following meet together: the oxidising agent, the ionised fuel, and also electrons from the electrical consumer load or an adjacent converter cell. At the second electrode there takes place the chemical reaction to form the educt, which is preferably discharged through passages of the second fluid supply device.

In the context of the invention a current conducting device is understood to be a device that in particular serves to conduct electrons between one of the electrodes of the electrode assembly and a consumer load, or between one of the electrodes and an adjacent converter cell. For this purpose the current conducting device is electrically connected, preferably materially connected, with one of the electrodes of the electrode assembly. The current conducting device is preferably connected, at least indirectly, with a consumer load that is to be supplied.

The current conducting device has an electrically conductive section with a metallic material, preferably aluminium and/or copper; it is particularly preferable for certain sections to be coated with nickel. The said configuration offers the advantage of reduced contact resistance. The current conducting device is preferably of a massive design with a metallic material. The material of the current conducting device preferably corresponds to the material of the collector film of the electrode, with which the current conducting device is connected, in particular materially connected. The said configuration offers the advantage of reduced contact corrosion between current conducting device and collector film.

The current conducting device has a second section that is arranged within the converter cell. The second section is electrically connected, preferably materially connected, with at least one of the electrodes of the electrode assembly, preferably with all electrodes of the same polarity.

The second section preferably has at least one collector tab. The collector tab is connected, in particular materially connected, with one of the electrodes of the electrode assembly, in particular with its collector film. The collector tab is designed as an electrically conductive strip, preferably as a metal film. The said configuration offers the advantage that any displacement between a plane of symmetry through the section of the current conducting device, which extends into the surroundings of the converter cell, and a plane through the said electrode, i.e., collector film, can be compensated for. It is particularly preferable for the second section to have a plurality of collector tabs. The collector tabs offer a plurality of current paths to the same electrode, as a result of which the current density of the current path is advantageously reduced, or to various electrodes of the same polarity of the electrode stack, as a result of which the electrodes of the same polarity are electrically connected in parallel.

The current conducting device preferably also has a first section that extends into the surroundings of the converter cell. The first section is electrically connected, at least indirectly, with a consumer load that is to be supplied, or with a second, in particular an adjacent, converter cell, in particular via a connecting device, preferably via a current rail, a current strip, or a connecting cable. In accordance with a preferred configuration, the first section is designed as a metal plate, or as a plate with a metallic coating. The said configuration offers the advantage that a mechanically stable, essentially planar surface is available for purposes of a simple, and/or as durable as possible, electrical connection with a connecting device.

The current conducting device preferably has an essentially plate-shaped metallic or metal-coated current collector. In the second section of the current conducting device the current collector is connected, in particular materially connected, with in particular all collector tabs of the same polarity. The material of the current collector preferably corresponds to the material of the collector tab. The said configuration offers the advantage that the current collector, for purposes of connecting with a connecting device and/or one of the housing parts, can be designed to be mechanically more robust than a film-type collector tab could be. In this manner the durability of the converter cell is improved. Furthermore the said configuration offers the advantage that the current collector can be connected with the cell housing, before the electrode assembly, with collector tabs secured thereon, is supplied to the cell housing.

In accordance with a preferred embodiment, the current collector extends out of the cell housing and also into the first section of the current conducting device, i.e. into the surroundings of the converter cell, and in particular is designed as a metal plate, a stamped part, and/or a pressed sheet part. The said configuration offers the advantage of lower manufacturing costs. The said configuration offers the further advantage that the current conducting device in the first section is designed to be sufficiently mechanically robust for purposes of connecting with a connecting device, for example a current rail, current strip, or current cable, which is not associated with the converter cell.

In accordance with a further preferred embodiment, the current collector is designed as a current collector with a contact surface. The said contact surface is essentially arranged in a cover surface of one of the said housing parts or extends only insignificantly into the surroundings. The contact surface is preferably provided for purposes of electrical connection with a spring-loaded connecting device. The said configuration offers the advantage that for transport or storage of the converter cell the contact surface can be covered with an insulating adhesive strip.

In the context of the present invention, a cell housing is understood to be a device, which in particular:
serves as a boundary between the electrode assembly and the surroundings,
serves to protect the electrode assembly from damaging environmental influences, in particular to protect it from water from the environment,
counteracts the exit of substances from the electrode assembly into the environment,
encloses the electrode assembly in what is preferably an essentially gas-tight manner.

The cell housing surrounds the electrode assembly, at least in certain sections, and preferably surrounds it essentially completely. Thus the cell housing is matched to the shape of the electrode assembly. The cell housing is preferably designed to be of an essentially quadrilateral shape, in the same manner as the electrode assembly, The cell housing preferably surrounds the electrode assembly such that at least one wall of the cell housing exerts a force onto the electrode assembly, wherein the force counteracts any undesirable movement of the electrode assembly relative to the cell housing. It is particularly preferable for the cell housing to accommodate the electrode assembly in a positive-locking fit and/or a force-locking fit. The cell housing is preferably electrically insulated relative to the surroundings. The cell housing is preferably electrically insulated relative to the electrode assembly.

The cell housing is designed with at least one first housing part that is essentially stiff in bending. The first housing part comprises at least one functional device which supports the output of energy from the electrode assembly, in particular to a consumer load. The first housing part has a first load-bearing element, which supports the at least one functional device relative to the surroundings of the converter cell. In particular the first housing part serves to provide a boundary between the electrode assembly and the surroundings of the converter cell, and also to protect the electrode assembly. In particular the first housing part serves to protect the electrode assembly. The first housing part preferably has a wall thickness of at least 0.3 mm. The material and the geometry of the first housing part are preferably selected such that its bending stiffness withstands the operational loads.

In the context of the invention, a functional device is understood to be a device which in particular serves the purpose of supporting trouble-free operation of the electrode assembly. The functional device is operationally connected with the electrode assembly. In the context of the invention, an active connection between functional device and electrode assembly is in particular understood to mean a connection whereby energy, an electric potential, materials and/or information, in particular concerning operating parameters of the electrode assembly, can be exchanged between the functional device and the electrode assembly. The at least one functional device preferably has at least one electrically conductive section. The at least one functional device preferably has at least one electrically insulating section, which particularly preferably serves as a mounting for functional elements. The functional device is preferably connected, in particular materially connected, with the first load-bearing element. The functional device is essentially completely covered by the first load-bearing element relative to the surroundings, insofar as the first load-bearing element does not have a pole contact opening.

The functional device is preferably electrically connected with at least one of the electrodes, particularly preferably with at least two electrodes of differing polarity. The said configuration offers the advantage that the functional device has the electrical potential of the connected electrode, and in particular can be supplied with energy from the electrode assembly.

The functional device is preferably designed as a diffusion barrier, with which any exchange of gas between the surroundings of the converter cell and the interior of the cell housing is countered.

The functional device is preferably designed as a populated and/or printed circuit board, in particular one that is flexible. The said configuration offers the advantage that the circuit board is protected by the first load-bearing element. The said configuration offers the advantage that in the event of extraction of the converter cell from a battery, the circuit board remains on the converter cell.

The functional device is preferably designed as flame protection or fire protection. For this purpose the functional device includes one of the said chemically reactive, flame-retarding materials, and is preferably designed as a coating, i.e. layer, and in particular one that essentially completely covers the adjacent electrode assembly. The said configuration offers the advantage that for the case of a fire occurring in its surroundings, the operational reliability of the converter cell is improved.

In the context of the present invention, a first load-bearing element is understood to be a device that is provided so as to support the at least one functional device, at least in certain sections. The first load-bearing element faces towards the surroundings of the converter cell. In the context of the present invention, “to support” is understood to mean that any undesirable movement of the at least one functional device relative to the first load-bearing element, i.e. relative to the converter cell, is countered. The first load-bearing element serves in particular the purpose of countering any undesirable displacement of the at least one functional device relative to the first load-bearing element, i.e. relative to the converter cell. The first load-bearing element serves in particular the purpose of protecting the at least one functional device, in particular from damaging influences from the surroundings of the converter cell. Thus the said design offers the advantage of protection of the electrode assembly against a foreign body impacting onto or even penetrating the cell housing, in particular without the requirement for separate protective devices.

The first load-bearing element has a first polymer material, in particular one that is interpenetrated by fibres, preferably a thermoplastic. The softening temperature of the polymer material preferably lies above the operating temperature range of the converter cell, particularly preferably by at least 10 K. The first load-bearing element preferably has a fibrous material, in particular with glass fibres, carbon fibres, basalt fibres, and/or aramide fibres, wherein the fibrous material serves in particular to stiffen the first load-bearing element. It is particularly preferable for the fibrous material to be designed in particular as a non-woven or woven fabric, and to be essentially completely surrounded by the first polymer material.

The at least one functional device is preferably connected, in particular materially connected, with the first load-bearing element.

The first load-bearing element is preferably designed as a first load-bearing layer. The said configuration offers the advantage that the at least one functional device can be supported along a larger surface area of the first load-bearing element, as a result of which, in particular, the integrity of the at least one functional device is improved.

The first load-bearing element preferably has one or two pole contact openings, which of which make a section of the adjacent functional device accessible, in particular electrically accessible, from the surroundings of the converter cell.

In what follows, advantageous configurations and preferred forms of embodiment of the converter cell according to the invention are described, as are their advantages.

The converter cell according to the invention preferably has at least two electrode assemblys, which are electrically connected in series in the cell housing. The said configuration offers the advantage that the nominal voltage of the converter cell is increased.

The at least one functional device preferably has at least one or a plurality of functional elements.

In the context of the invention, a functional element is understood to be an element, which in particular serves the purpose of supporting trouble-free operation of the electrode assembly. In particular the functional element serves to provide:
the electrical connection of the electrode assembly with the surroundings of the converter cell, and/or
the in particular electrical connection of the at least one or a plurality of the said functional devices with the electrode assembly, and/or
the supply of energy in particular from the electrode assembly to at least one or a plurality of the said functional devices, and/or
the influencing, i.e. limiting, of the electrical current, which flows into the electrode assembly, or is extracted from the electrode assembly, and/or
the control of the converter cell, i.e. the electrode assembly, and/or
the registration of operating parameters of the converter cell, in particular of operating parameters of the electrode assembly, and/or
the exchange of thermal energy with the electrode assembly, preferably the removal of heat from the electrode assembly, and/or
the supply or removal of a flow of fluid of a chemical substance, and/or
the registration of the safety state of the converter cell, the defect analysis, the registration and/or communication of the state, and/or
the communication with the surroundings, in particular with a battery controller, or with an independent controller.

At least one or a plurality of the said functional elements is/are preferably designed as:
a pole contact section, which is accessible from the surroundings of the converter cell, in particular through a pole contact opening in the first load-bearing element, which in particular is arranged on an external surface of the cell housing, wherein the pole contact section has the electrical potential of one of the electrodes of the electrode assembly, wherein the said configuration offers the advantage that at least one of the said current conducting devices can be designed without a first section,
an electrode connection section, which serves to provide the electrical connection of the functional device with the electrode assembly, which serves in particular to supply the functional device, which serves in particular to provide the electrical connection with one of the current conducting devices of the converter cell,
a voltage probe, current probe, temperature probe, i.e. thermocouple, pressure sensor, sensor for a chemical material, hereinafter referred to as “material sensor”, gas sensor, fluid sensor, location sensor or acceleration sensor, wherein the sensors serve in particular to register the operating parameters of the converter cell, in particular of the electrode assembly,
a control device, in particular a cell control device, an application-specific integrated circuit, a microprocessor or data storage device, which serve in particular to control the converter cell, i.e. its electrode assembly,
a positioning device, pressure release device actuator, switching device, discharge resistance, current limiter or current interrupter, which serve in particular to execute remedial actions relating to detected, in particular undesirable, operating states of the converter cell, which serve in particular to influence, i.e. limit, the electrical current into the electrode assembly or out of the electrode assembly,
a conducting track, which serves to provide the electrical connection of at least two or a plurality of the said functional elements with each other,
an opening, which enables the connection of bodies that are spaced apart by the functional device, or which enables a body to extend through the functional device,
a heat exchange section, which serves to exchange thermal energy with the electrode assembly,
a fluid passage, which serves to exchange a chemical substance with the electrode assembly, or as
a bleeper, light emitting diode, infrared interface, GPS device, GSM module, first short-range radio device or transponder, which serve in particular to provide the communication with a battery controller or with an independent controller, which serve to provide the transfer of data, in particular to a battery controller or an independent controller, which serve in particular to provide the display of, in particular, a predetermined operating state of the converter cell, i.e. of the electrode assembly.

The first short-range radio device is preferably provided so as to transmit a predetermined second signal temporarily, in particular upon a command, i.e. upon a predetermined first signal, from a second short-range radio device, wherein the second short-range radio device is connected in terms of signals with a battery controller. It is particularly preferable for the first short-range radio device to be provided so as to transmit an identifier for the converter cell simultaneously with the predetermined second signal.

A plurality of functional elements preferably act together for trouble-free operation of the electrode assembly. It is particularly preferable for the said functional elements to be electrically connected to each other.

A first preferred configuration of the functional device includes as functional elements at least:
one of the said current probes for the registration of the electrical current, which is supplied to the electrode assembly or extracted from the electrode assembly, hereinafter also referred to as the cell current,
one of the said voltage probes for the registration of the electrical voltage of the electrode assembly,
one of the said thermocouples for the registration of the temperature of the electrode assembly, or one of the said current conducting devices,
one of the said cell control devices for the processing of signals of, in particular, the previously cited measurement probes,
one, preferably two, of the said electrode connection sections, which are connected with one, preferably two, of the said electrodes in particular of differing polarity, which preferably serve to provide the supply of the cell control device and/or at least one of the said measurement probes with electrical energy,
at least two or a plurality of the said conducting tracks to provide the electrical connections of the other functional elements of the said functional device,
preferably at least one or a plurality of the said switching devices, the said current interrupters and/or the said current limiters,
preferably the said data storage device, which serves to store and/or prepare data and/or calculation rules,
preferably the said first short-range radio device, which serves to provide the exchange of data with a battery controller, i.e. with its second short-range radio device,
preferably two cell control terminals, which serve to provide the connections with a data bus of a higher level battery, which serve to exchange data with a battery controller,
preferably two heat exchange sections, which serve to exchange thermal energy with the electrode assembly and with a heat exchanger that is not associated with the converter cell.

The said preferred configuration of the functional device offers the advantage that the functional device can serve to control and/or monitor the electrode assembly. The said configuration offers the advantage that in the event of the extraction of the converter cell from a battery, the functional device remains on the converter cell.

In accordance with a first preferred development of the said preferred configuration, the functional device is designed with a circuit board, which is populated with the said functional elements, which has conducting tracks for purposes of connecting with the other functional elements. The said preferred development offers the advantage that in the production of the first housing part, the circuit board can be supplied with little effort, i.e. it can be placed onto said first load-bearing element. The said preferred development offers the advantage that in the event of the extraction of the converter cell from a battery the circuit board remains on the converter cell.

In accordance with a further preferred development of the said preferred configuration, the functional device is designed with a flexible film, in particular of polyimide or Kapton®, which is populated with the said functional elements, which has conducting tracks for the purpose of connecting with the other functional elements. The said preferred development offers the advantage that in the production of the first housing part, the functional device can be supplied with little effort, i.e. it can be placed onto said first load-bearing element. The said preferred development offers the advantage that in the event of the extraction of the converter cell from a battery, the functional device remains on the converter cell.

At least one or a plurality of the said functional devices are preferably:
of a porous design at least in certain sections, particularly preferably with a foam, with which in particular a predetermined external geometry of the converter cell can be achieved, with which in particular the bending stiffness of the first housing part is increased, with which, in particular in certain sections, a volume is formed for the retardation or capture of a foreign body impacting onto the converter cell, with which in particular a section of the first housing part is formed with a reduced thermal conductivity, and/or
designed with a voided structure, in particular with a honeycomb structure, with which in particular the bending stiffness of the first housing part is increased, with which, in particular in certain sections, a volume is formed for the retardation or capture of a foreign body impacting onto the converter cell, with which in particular a section of the first housing part is formed with a reduced thermal conductivity, and/or
designed with at least one void, in particular for a temperature-regulating medium, wherein the temperature-regulating medium serves to exchange thermal energy with the electrode assembly, wherein the temperature-regulating medium flows through the void, in particular if the temperature of the electrode assembly exceeds or falls below a limiting temperature, and/or
designed, at least in certain sections, with an expandable filler, which is provided so as to form voids, in particular with the supply of a activation energy, in particular to form voids when triggered by a functional element, and/or
designed, at least in certain sections, with a filler (PCM) with the ability to undergo a phase change, in particular within the predetermined operating temperature range of the converter cell, wherein the filler temporarily exchanges thermal energy, in particular with the electrode assembly, for purposes of heating or cooling the latter, and/or
designed, at least in certain sections, with a chemically reactive filler, which is preferably provided so as to chemically bind a substance, in particular from the electrode assembly, preferably after the release of the substance from the electrode assembly, and/or
designed with a first layered section with a first wall thickness (thick) and a second layered section with a second wall thickness (thin), wherein the fraction formed by the second wall thickness divided by the first wall thickness has a predetermined value that is less than 1, preferably less than 0.9, preferably less than 0.8, preferably less than 0.7, preferably less than 0.6, preferably less than 0.5, preferably greater than 0.05, wherein the first layered section preferably has a lower density than the second layered section.

In accordance with a first preferred embodiment the expandable filler is formed by an organic aerogel with a three-dimensional lattice of primary particles. With pyrolysis or intensive thermal radiation, the said primary particles grow towards one another without any kind of order, wherein voids arise between the particles. By means of said voids the thermal permeability of the functional device is reduced. The said embodiment offers the advantage of an improved flame resistance for the first housing part.

In accordance with a further preferred embodiment the expandable filler is formed in terms of expanded mica, or vermiculite. Water of crystallisation is chemically bound between the layers of its biscuit structure. With thermal action the chemically bound water is driven out impulsively, whereby the vermiculite is expanded to a multiple of its original volume.

The chemically reactive filler preferably acts as a flame retardant, in particular by the formation of a protective layer or by the interruption of a chain reaction with radicals. The filler is preferably selected from the following group, which includes: alum, borax, aluminium hydroxide, materials of the form M^{I}M^{III}(SO₄)₂ and with water of crystallisation, wherein M stands for a metal ion of oxidation level I or III, particularly preferably potassium alum. In accordance with a first preferred embodiment the functional device is designed as an inlay impregnated with the filler, particularly preferably as a cotton layer. In accordance with a second preferred embodiment the functional device is pressed out of a powder of the filler. The said preferred embodiment offers the advantage that in the event of a fire in the surroundings of the converter cell the protection of the electrode assembly is improved.

The converter cell, i.e. its cell housing, preferably has a second housing part.

In the context of the invention, a second housing part is understood to be a device which in particular is provided to be connected, or to become connected, with the first housing part, at least in certain sections. The second housing part is provided so as to form, with the first housing part, the cell housing of the converter cell. The first housing part and the second housing part preferably surround the electrode assembly essentially completely and in particular counteract any exchange of substances between the electrode assembly and the surroundings of the converter cell. The second housing part has at least one first load-bearing element, which corresponds essentially to the load-bearing element of the first housing part. The second housing part preferably has at least one of the said functional devices. It is particularly preferable for the second housing part to be designed so as to be essentially identical to the first housing part. The said configuration offers the advantage that production costs and stocks stored are reduced.

In a first preferred embodiment of the cell housing the first housing part and the second housing part are connected to each other via a hinged section. The hinged section extends along an edge of the first housing part and the second housing part. The hinged section preferably has a lower wall thickness than the sections of the housing parts that bound the electrode assembly. The said embodiment offers the advantage that the length of the edges to be sealed of the in particular quadrilateral cell housing, is reduced.

In a second preferred embodiment of the cell housing the first housing part and the second housing part are spaced apart by means of a frame. The housing parts are connected, in particular materially connected, with the frame. The frame has essentially four frame elements, which are arranged relative to one another in the form of a rectangle. The frame demarcates a space in which the electrode assembly can be accommodated. Also a converter cell without any functional devices with a cell housing formed with a frame has been designated as a flat cell frame. The frame is preferably formed with the second polymer material; it is particularly preferable for it to be formed essentially completely from the second polymer material. The said preferred embodiment offers the advantage that each of the housing parts can be designed without any accommodation space. In accordance with a preferred development two of the said current conducting devices extend through the frame at least partially into the surroundings. In accordance with a further preferred development at least one of the said two housing parts has one or two of the said pole contact sections.

The first housing part and/or the second housing part preferably has an accommodation space, which can accommodate the electrode assembly, at least partially.

The said accommodation space is preferably dimensioned such that after closing the housing parts around the electrode assembly to form a cell housing, a frictional force is present between at least one inner surface of the cell housing and a cover surface of the electrode assembly. The said frictional force counteracts any undesirable relative movement between the cell housing and the electrode assembly.

In accordance with a preferred configuration the accommodation spaces of the first housing part and the second housing part are designed so as to be identical. In the said preferred configuration essentially half of the electrode assembly is accommodated in each of the housing parts. The said configuration offers the advantage that production costs and stocks stored are reduced.

In accordance with a further preferred configuration the first housing part accommodates the electrode assembly essentially completely. The first housing part is preferably designed as a tub. The electrode assembly is arranged in the interior of the tub, wherein the interior space corresponds to the accommodation space. At least one functional device is arranged in the multi-layer wall of the tub. In the said preferred configuration the second housing part is designed essentially as a flat cover, without accommodation space and/or without a functional device, for purposes of closing the first housing part. The said configuration offers the advantage that the second housing part can be designed more cost effectively. In accordance with a preferred development two of the said current conducting devices extend through the wall of the tub, or through the wall of the cover, at least partially into the surroundings. In accordance with a further preferred development, the cover and/or the tub have two of the said pole contact sections.

The first and/or the second housing part preferably have a second load-bearing element, which is arranged between at least one of the said functional devices and the electrode assembly.

In the context of the invention, a second load-bearing element is understood to be a device that is provided so as to stiffen the housing part. The second load-bearing element is preferably arranged between the at least one functional device and the electrode assembly. The second load-bearing element is preferably designed as a second load-bearing layer. The second load-bearing element has a first polymer material, in particular one that is interpenetrated by fibres, and is preferably a thermoplastic. The softening temperature of the polymer material preferably lies above the operating temperature range of the converter cell, particularly preferably by at least 10 K. The second load-bearing element preferably has a fibrous material, in particular with glass fibres, carbon fibres, basalt fibres, and/or aramide fibres, which serve in particular to stiffen the second load-bearing element. The fibrous material is preferably designed in particular in the form of a textile, as a non-woven or woven fabric, and particularly preferably is surrounded essentially completely by the first polymer material. The said configuration offers the further advantage that the second load-bearing element separates the at least one functional device from the substances of the electrode assembly.

It is particularly preferable for the second load-bearing element to be connected, in particular materially connected, with the at least one functional device. The said configuration offers the advantage that the second load-bearing layer additionally stiffens, i.e. mechanically stabilises, the housing part.

It is particularly preferable for the second load-bearing element to be designed so as to correspond with the first load-bearing element, in particular in terms of material. The said configuration offers the advantage of reduced production costs.

It is particularly preferable for the second load-bearing element to be designed so as to be thinner than the first load-bearing element, and in particular without fibrous material. The said configuration offers the advantage that the time constant is reduced when registering the temperature of the electrode assembly and/or the cell internal pressure.

It is particularly preferable for the second load-bearing element to have at least one opening, which enables a sensor of the functional device to make direct contact with the electrode assembly for the purpose of detecting a substance. The said configuration offers the advantage that the presence of hydrogen fluoride, hereinafter also referred to as HF, can be detected with a lower time constant.

It is particularly preferable for the second load-bearing element to have at least one contact opening, in particular in an edge section of the housing part, which in particular serves to provide the electrical connection between the functional device adjacent to the second load-bearing element and one of the current conducting devices of the converter cell. The said configuration offers the advantage that the functional device has the electrical potential of one of the electrodes of the electrode assembly. The said configuration offers the further advantage that the functional device can be supplied with energy from the electrode assembly.

The first and/or second housing part preferably have/has a second polymer material in an edge section. The second polymer material serves in particular to provide the material connection with one of the other housing parts; it is particularly preferable for it to provide the material connection of the first housing part with the second housing part. The softening temperature of the polymer material preferably lies above the range of operating temperatures of the converter cell, particularly preferably by at least 10 K. The said configuration offers the advantage that the durable sealing of the interior of the cell housing is improved.

It is particularly preferable for the second polymer material to be designed as a thermoplastic, in particular with a softening temperature above the operating temperature range of the converter cell. The said configuration offers the advantage of a simplified supply of the second polymer material into a processing device, in particular into a moulding tool. The said configuration offers the further advantage of an intimate, in particular a gas-tight, connection of the second polymer material with the respective housing part.

It is particularly preferable for the second polymer material to enclose an edge section of the first and/or second housing part. The said configuration offers the advantage of an intimate, in particular a gas-tight, connection of the second polymer material with the respective housing part.

It is particularly preferable for the second polymer material to correspond to the first polymer material. The said configuration offers the advantage of an intimate, in particular a gas-tight, connection of the second polymer material with the first polymer material.

The converter cell, in particular its cell housing, preferably has an essentially plate-shaped third housing part.

In the context of the invention, a third housing part is understood to be a device that in particular is provided so as to be connected, at least in certain sections, with the first housing part. The third housing part is provided so as to be connected, in particular materially connected, at least in certain sections with the first housing part, and/or to form with the first housing part the cell housing of the converter cell. Compared with the first housing part the third housing part has a higher thermal conductivity. The said configuration offers the advantage that the third housing part contributes to the improved removal of heat from the electrode assembly.

The third housing part preferably comprises a metal; it is particularly preferable for this to be aluminium and/or copper. The said configuration offers the advantage that the third housing part contributes to the improved removal of heat from the electrode assembly. The said configuration offers the further advantage that the protection of the electrode assembly against damaging impacts from the surroundings of the converter cell is improved.

The third housing part preferably has a first heat transfer section, which is provided so as to exchange thermal energy with the electrode assembly. It is particularly preferable for the said heat transfer section to have geometries for increasing the surface area, in particular protrusions, pins, cones and/or ribs, which are facing towards the surroundings of the converter cell. The said configuration offers the advantage that the third housing part contributes to the improved removal of heat from the electrode assembly.

The third housing part preferably has a second heat transfer section, which is provided so as to exchange thermal energy with a temperature-regulating device that is not associated with the converter cell. It is particularly preferable for the second heat transfer section to be polished. The said configuration offers the advantage that the surface area for thermal contact with the temperature-regulating device is increased. The said configuration offers the advantage that the third housing part contributes to the improved removal of heat from the electrode assembly.

The surface of the third housing part facing towards the electrode assembly, i.e. towards the first housing part, is preferably coated in an electrically insulating manner. The said configuration offers the advantage that the third housing part does not have the electrical potential of the electrode assembly.

The third housing part preferably has an electrode connection section and also a pole contact section. The electrode connection section and the pole contact section are electrically connected to each other. The said configuration offers the advantage that contact can be made with the electrode assembly via the third housing part. The said configuration offers the further advantage that at least one of the current conducting devices can be designed without a first section.

At least one or two of the said current conducting devices preferably comprise(s) at least one contact section each. The contact section serves in particular to provide the electrical connection with at least one or a plurality of the said functional devices, preferably to provide the electrical supply to at least one or a plurality of the said functional devices. At least one of the said contact sections preferably comprises a metal; it is particularly preferable for this to be aluminium and/or copper.

The contact section is preferably arranged in an edge section of the first housing part, in particular in the section of the second polymer material. The second polymer material preferably exposes the contact section to at least one of the said electrode connection sections. The said configuration offers the advantage that the contact section is held in an essentially rigid manner by the second polymer material relative to the first housing part. The said configuration offers the further advantage that the second polymer material protects the electrical connection between the contact section and the electrode connection section of the functional device from chemical attack from the surroundings of the converter cell.

The contact section is preferably designed as a projection, which extends in the direction of the functional device, in particular through one of the contact openings. It is particularly preferable for the contact section to be designed as a hump or projection. The said configuration offers the advantage that the connection between current conducting device and functional device can easily be automated.

The connection between contact section and electrode connection device is preferably designed so as to be materially connected; particular preferably by means of a friction welding method or an ultrasound welding method. The said configuration offers the advantage that the connection between current conducting device and functional device can easily be automated.

At least one of the said current conducting devices preferably has, in particular in its second section, a plurality of collector tabs. The said plurality of collector tabs is materially connected with the same electrode of the electrode assembly designed as an electrode coil, or with a plurality of electrodes of the same polarity of the electrode assembly designed as an electrode stack. The collector tabs of the same polarity are connected, in particular materially connected, with the current collector of the same current conducting device in the interior of the cell housing. The said current collector also extends into the first section external to the cell housing. The current collector is preferably connected, in particular materially connected, with the first housing part in its edge section. It is particularly preferable for the current collector to extend through the second polymer material in the edge section of the first housing part. Thus in a first production step, the current collector can be materially connected, in particular in a gas-tight manner, with the first housing part and in a next production step the collector tabs can be materially connected, in particular welded, to the current collector. The said configuration offers the advantage that in the absence of the electrode assembly the input of thermal energy during the first production step does not contribute to its heating, i.e. accelerated ageing.

The at least one functional device of the converter cell, i.e. of the first housing part, is preferably arranged between the first load-bearing element and the second load-bearing element and is connected, in particular materially connected, with the load-bearing elements, at least in certain sections.

The first load-bearing element preferably has one or two of the said pole contact openings, which make one or two of the said pole contact sections of the functional device accessible, in particular electrically, from the surroundings.

The second load-bearing element preferably has one or two of the said contact openings, which are arranged adjacent to one or two of the said electrode connection sections of the functional device. The said configuration offers the advantage that an exchange of electrons with the electrode assembly is enabled, even without a first section of the current conducting device extending into the surroundings.

In accordance with a preferred development of the first housing part, the first load-bearing element has two pole contact openings, the functional device has two pole contact sections of differing polarity, the second load-bearing element has two contact openings, and the functional device has two electrode connection sections of differing polarity. The said development offers the advantage that the second or third housing part can be designed without a pole contact section, as a result of which, in particular, the associated manufacturing costs are reduced.

A temperature probe or thermocouple is preferably integrated into the second section of the current conducting device, in particular into its current collector. The supply lines to the temperature probe or thermocouple terminate in the edge section of the first housing part, in particular on two contact surfaces in the section of a opening in the second load-bearing element. Two terminal connections to the functional device are also arranged in the section of the said opening, and are electrically connected with the contact surfaces. The said configuration offers the advantage that a temperature measurement is enabled in the current conducting device.

The converter cell preferably has a housing module with a first housing part and with at least one or two of the said current conducting devices of differing polarity. The said housing module serves in particular to simplify the production of the converter cell. The first housing part comprises a layered composite, in particular a materially connected layered composite, with the first load-bearing element, the at least one functional device, and the second load-bearing element. Furthermore the first housing part preferably has the second polymer material in its edge section. An edge section of the first housing part is preferably enclosed by the second polymer material, at least in certain sections. Furthermore the first housing part has the accommodation space that is provided in order to accommodate the electrode assembly, at least partially. The at least one of the said current conducting devices, in particular its current collector, has the said contact section, which is arranged in the edge section of the first housing part, preferably in the second polymer material. The second load-bearing element has in the contact section of at least one or two of the said current conducting devices at least one or two of the said contact openings. The contact section is in particular electrically connected through the contact opening with the functional device, in particular with its electrode connection section. The said configuration offers the advantage that the housing module can be prepared independently.

The electrode assembly is inserted into its accommodation space only after the said housing module has been completed. The said preferred configuration offers the further advantage that inputs of thermal energy in the course of the formation of the accommodation space, in the course of the arrangement of the second polymer material on the first housing part, and/or in the course of the connection, in particular material connection, of the current conducting device and the first housing part during the manufacture of the said housing module, cannot lead to heating, i.e. accelerated ageing, of the electrode assembly.

At least one of the said functional devices, in particular of the first housing part, preferably comprises the said cell control device, at least one or two of the said electrode connection sections and at least one or a plurality of the said measurement probes. The at least one measurement probe is provided so as to register an operating parameter of the converter cell, in particular of its electrode assembly, and to make it available to the cell control device.

In the context of the present invention, an operating parameter is understood to be a parameter, in particular of the converter cell, which in particular:
allows a conclusion to be drawn on the presence of a desirable or predetermined operating state of the converter cell, i.e. of its electrode assembly, and/or
allows a conclusion to be drawn on the presence of an unplanned or undesirable operating state of the converter cell, i.e. of its electrode assembly, and/or
can be established by means of a measurement probe or sensor, wherein the measurement probe provides a signal, at least temporarily, preferably an electrical voltage or an electrical current, and/or
can be processed by a control device, in particular a cell control device, in particular can be compared with a target value, in particular can be combined with another registered parameter, and/or
provides information concerning the cell voltage, the cell current, i.e. the level of the electrical current into the electrode assembly, or out of the electrode assembly, the cell temperature, the internal pressure of the converter cell, the integrity of the converter cell, the release of a substance from the electrode assembly, the presence of a foreign substance, in particular from the surroundings of the converter cell, and/or the charging state, and/or
suggests a transfer of the converter cell into another operating state.

The cell control device is provided so as to control at least one operating procedure of the converter cell, in particular the charging and/or discharging of the electrode assembly. The cell control device preferably monitors an operating state of the converter cell. The cell control device preferably initiates the transfer of the converter cell into a predetermined operating state. The cell control device preferably displays the state of the converter cell via a display device, in particular via at least one LED. The said preferred configuration offers the advantage that the cell control device is arranged in the first housing part in a protected manner. The said preferred configuration offers the further advantage that the converter cell has its own cell control device for purposes of operating and/or monitoring the electrode assembly, which also remains on the converter cell if the converter cell is removed from a battery.

The cell control device is preferably provided so as to initiate the transfer of the converter cell into a “safe” state, wherein the charge of the converter cell in the safe state is a maximum of half the nominal charge capacity, wherein in particular the cell voltage in the safe state is a maximum of 3 V. The said preferred configuration offers the advantage that the converter cell can be transferred into the safe state of the converter cell even when outside a battery pack.

In accordance with a first preferred development, the functional device includes a first short-range radio device, which is connected in terms of signals with the cell control device. The said first short-range radio device serves in particular to provide the wireless communication with a higher level battery controller, in particular with its second short-range radio device, The first short-range radio device is preferably configured so as to transmit, in particular periodically, a predetermined signal to a higher level battery controller. The said development offers the advantage that the battery controller can integrate the affiliated converter cell onto the predetermined signal for purposes of supplying a consumer load. The said development offers the further advantage that the battery controller can isolate a converter cell in the absence of the predetermined signal.

In accordance with a further preferred development, the functional device includes two cell control terminals and the first load-bearing element has two openings in the section of the said cell control terminals. The converter cell can be connected via the cell control terminals to a data line, or a data bus. The said preferred development offers the advantage that the cell controller can communicate via the two cell control terminals with the higher level battery controller.

The converter cell preferably has a nominal charge capacity of at least 3 ampere-hours [Ah], further preferred of at least 5 Ah, further preferred of at least 10 Ah, further preferred of at least 20 Ah, further preferred of at least Ah, further preferred of at least 100 Ah, further preferred of at least 200 Ah, further preferred of at most 500 Ah. The said configuration offers the advantage of an improved operational life for the consumer load supplied by the converter cell.

The converter cell preferably has a nominal current of at least 50 A, further preferred of at least 100 A, further preferred of at least 200 A, further preferred of at least 500 A, further preferred of at most 1000 A. The said configuration offers the advantage of an improved performance for the consumer load supplied by the converter cell.

The converter cell preferably has a nominal voltage of at least 1.2 V, further preferred of at least 1.5 V, further preferred of at least 2 V, further preferred of at least 2.5 V, further preferred of at least 3 V, further preferred of at least 3.5 V, further preferred of at least 4 V, further preferred of at least 3.5 V, further preferred of at least 4.5 V, further preferred of at least 3.5 V, further preferred of at least 5 V, further preferred of at least 5.5 V, further preferred of at least 6 V, further preferred of at least 6.5 V, further preferred of at least 7 V, further preferred of at most 7.5 V. The electrode assembly preferably has lithium ions. The said configuration offers the advantage of an improved energy density for the converter cell.

The converter cell preferably has an operating temperature range of between −40° C. and 100° C., further preferred of between −20° C. and 80° C., further preferred of between −10° C. and 60° C., further preferred of between 0° C. and 40° C. The said configuration offers the advantage of a deployment or use of the converter cell for purposes of supplying a consumer load, in particular a motor vehicle, or a stationary plant, or a machine, which is as unrestricted as possible.

The converter cell preferably has a gravimetric energy density of at least 50 Wh/kg, further preferred of at least 100 Wh/kg, further preferred of at least 200 Wh/kg, further preferred of less than 500 Wh/kg. The electrode assembly preferably has lithium ions. The said configuration offers the advantage of an improved energy density for the converter cell.

In accordance with a preferred embodiment, the converter cell is provided with at least one electric motor for installation into a vehicle. The converter cell is preferably provided for purposes of supplying the said electric motor. It is particularly preferable for the converter cell to be provided so as to supply, at least temporarily, an electric motor of a drive train of a hybrid or electric vehicle. The said configuration offers the advantage of an improved supply for the electric motor.

In accordance with a further preferred embodiment, the converter cell is provided for deployment in a stationary battery, in particular in a buffer store, as a device battery, industrial battery, or starter battery. The nominal charge capacity of the converter cell for the said applications is preferably at least 50 Ah. The said configuration offers the advantage of an improved supply for a stationary consumer load, in particular for an electric motor in a stationary installation.

In accordance with a first preferred embodiment, the at least one separator, which does not conduct electrons, or only poorly conducts electrons, consists of a supporting surface that is at least partially permeable to materials. The supporting surface is preferably coated on at least one side with an inorganic material. An organic material is preferably used as the supporting surface that is at least partially permeable to matter; this is preferably configured as a non-woven fabric. The organic material, which preferably contains a polymer, and particularly preferably a polyethylene terephthalate (PET), is coated with an inorganic material, preferably an ion-conducting material, which furthermore is preferably ion-conducting in a temperature range from −40° C. to 200° C. The inorganic material preferably comprises at least one compound from the group of oxides, phosphates, sulphates, titanates, silicates, aluminosilicates with at least one of the elements Zr, Al, Li, particularly preferably zircon oxide. In particular zircon oxide serves to provide the material integrity, nanoporosity and flexibility of the separator. The inorganic ion-conducting material preferably has particles with a maximum diameter of less than 100 nm. The said embodiment offers the advantage that the durability of the electrode assembly at temperatures above 100° C. is improved. Such a separator is, for example, marketed under the trade name “Separion” by Evonik AG in Germany.

In accordance with a second preferred embodiment, the at least one separator, which does not conduct electrons, or only poorly conducts electrons, but can conduct ions, consists at least predominantly or completely of a ceramic, preferably an ceramic oxide. The said embodiment offers the advantage that the durability of the electrode assembly at temperatures above 100° C. is improved.

### Preferred Forms of Embodiment of the Converter Cell

A first preferred embodiment of the converter cell preferably has, on the said electrode assembly, first and second said current conducting devices of differing polarity, and the said cell housing. The electrode assembly is designed in particular as a rechargeable flat electrode coil, in particular as a rechargeable electrode stack or converter assembly, each with at least one electrode of first and second polarity.

The current conducting devices have at least one or a plurality of the collector tabs, wherein for each current conducting device the at least one collector tab is electrically connected with the current collector in the cell housing. The first current conducting device, in particular its collector tab, is electrically connected with the electrode of first polarity. The second current conducting device, in particular its collector tab, is electrically connected with the electrode of second polarity. Furthermore the said current conducting devices each comprise one of the current collectors, which advantageously extend into the surroundings of the converter cell, in particular for a simplified electrical connection with a connecting device. The collector tabs and the current collector of at least one of the current conducting devices are connected, in particular materially connected.

The cell housing comprises the first housing part. The first housing part comprises the first load-bearing element, the second load-bearing element, and at least one or a plurality of the said functional devices, each with at least one or a plurality of the said functional elements. The load-bearing elements each comprise a first polymer material, in particular one that is interpenetrated by fibres. The first load-bearing element demarcates the at least one of the said functional devices from the surroundings of the converter cell. The second load-bearing element demarcates the at least one of the said functional devices from the electrode assembly of the converter cell. The at least one functional device is arranged between the first and second load-bearing elements. The first load-bearing element, preferably also the second load-bearing element, is connected, in particular materially connected, with at least one of the functional devices, at least in certain sections. The second load-bearing element has one or two of the said contact openings, as a result of which the adjacent functional device is exposed in certain sections to the electrode assembly. In its edge section the first housing part has the second polymer material, which preferably encloses the edge section of the first housing part. The current collector of at least the first current conducting device is led through the second polymer material. The current collector of the second current conducting device is preferably led through the second polymer material. The second polymer material preferably connects the edge section of the first housing part and the current collector of the first current conducting device, preferably also the current collector of the second current conducting device, in a materially connected and/or gas-tight manner. The first housing part preferably has an accommodation space, which accommodates the electrode assembly, at least partially.

The at least one functional device is operationally connected, in particular electrically connected, with the electrode assembly. The at least one functional device has one, preferably two, of the said electrode connection sections, which serve to provide the electrical connection with the electrode assembly. The two current connection devices each have one of the said contact sections, wherein the contact sections serve to provide the electrical connection with the at least one functional device, in particular via their electrode connection sections. The first electrode connection section of the at least one functional device and the contact section of the first current connection device are electrically connected to each other, preferably in a material connection, in particular in the section of the first contact opening. The second electrode connection section of the at least one functional device is preferably electrically connected with the contact section of the second current connection device, preferably in a material connection, in particular in the section of the second contact opening. The at least one functional device is preferably designed as a populated circuit board, in particular one that is flexible. It is particularly preferable for the functional device to have the said cell control device.

The cell housing furthermore has a second housing part. The second housing part has at least the first load-bearing element, with a first polymer material, in particular one that is interpenetrated by fibres. Together with the first housing part the second housing part forms the cell housing around the electrode assembly. In its edge section the second housing part preferably has the second polymer material, which particularly preferably encloses the edge section of the second housing part. The current collector of the second current conducting device is preferably led through the second polymer material. The second polymer material preferably connects the edge section of the second housing part and the current collector of the second current conducting device in a materially connected and/or gas-tight manner. The second housing part preferably has an accommodation space, which accommodates the electrode assembly, at least partially. The cell housing preferably surrounds the electrode assembly such that a frictional force between cell housing and electrode assembly counteracts any undesirable relative movement between them.

The said preferred embodiment offers the advantages, that:
the functional device is protected by the first load-bearing element from damaging influences from the surroundings of the converter cell.
any damaging consequences of vibrations occurring during operation on the functional device are counteracted.
the functional device is held in the cell housing in an essentially rigid manner.
the functional device remains on the converter cell, in particular in the event of an accident,
the cell control device controls and monitors the functions of the converter cell, in particular of its electrode assembly, also independently of a battery controller, in particular if the converter cell is not part of a battery.

In accordance with a first preferred development of the said preferred embodiment, the current collector of the first current conducting device is led through the second polymer material of the first housing part and the current collector of the second current conducting device is led through the second polymer material of the second housing part. The said development offers the advantage that the manufacture of the first and second housing parts can be undertaken with a number of identical production steps, as a result of which the production effort is reduced.

In accordance with a second preferred development of the said preferred embodiment, both current collectors are led through the second polymer material of the first housing part. Furthermore the accommodation space of the first housing part is dimensioned such that the electrode assembly occupies space essentially completely in the former. The said development offers the advantage that the second housing part can remain essentially without any accommodation space, as a result of which the associated production effort is reduced. The said development offers the further advantage that after the insertion of the electrode assembly into the accommodation space the electrical connections of collector tabs and current collectors can be manufactured in a simplified manner, in particular as a consequence of improved access.

In accordance with a third preferred development of the said preferred embodiment, the first housing part and the second housing part are connected to each other via a hinged section. The hinged section extends along a bounding edge of both the first housing part and the second housing part. The hinged section preferably has a lower wall thickness than the sections of the housing components that bound the electrode assembly. It is particularly preferable for the hinged section to be designed as a film hinge. The said configuration offers the advantage that the length of the edges of the cell housing that are to be sealed, is reduced. The said preferred development can be combined with the first or second preferred development.

In accordance with a fourth preferred development of the said preferred embodiment the first housing part and the second housing part are spaced apart by means of a frame. The housing parts are connected, in particular materially connected, with the frame. The frame has essentially four frame elements, which are arranged relative to one another in the form of a rectangle. The frame bounds a space, which is provided for purposes of accommodating the electrode assembly. The frame is preferably formed using the second polymer material, particularly preferably essentially completely from the second polymer material. The said preferred development offers the advantage that both housing parts can be designed without an accommodation space. In accordance with a preferred development two of the said current conducting devices extend through the frame at least partially into the surroundings. In accordance with a further preferred development at least one of the housing parts has one or two of the said pole contact sections.

A second preferred embodiment of the converter cell corresponds essentially to the first preferred embodiment, except that the cell housing includes the third housing part instead of the second housing part.

The third housing part has an enhanced thermal conductivity compared with the first housing part. The third housing part preferably comprises a metal, particularly preferably aluminium and/or copper. The third housing part is preferably designed in the form of a plate. The third housing part has a first heat transfer section, with which the electrode assembly is in thermal contact, and with which the electrode assembly can exchange thermal energy, in particular to cool the electrode assembly if its temperature lies above a maximum permissible temperature. Together with the first housing the second housing part forms the cell housing around the electrode assembly.

Both current collectors are preferably led through the second polymer material of the first housing part. Furthermore the accommodation space of the first housing part is dimensioned such that the electrode assembly occupies space essentially completely in the former. The said embodiment offers the further advantage that after the insertion of the electrode assembly into the accommodation space, the electrical connections of collector tabs and current collectors can be manufactured in a simplified manner, in particular as a consequence of improved access.

The said preferred embodiment offers the advantages, that:
the functional device is protected by the first load-bearing element against damaging influences from the surroundings of the converter cell.
any damaging consequences of vibrations occurring during operation on the functional device are counteracted.
the functional device is held in the cell housing in an essentially rigid manner.
the functional device remains on the converter cell, in particular in the event of an accident,
the cell control device controls and monitors the functions of the converter cell, in particular of its electrode assembly, also independently of a battery controller, in particular if the converter cell is not part of a battery.
thermal energy can be exchanged with the electrode assembly via the third housing part,
accelerated ageing of the electrode assembly can be prevented by means of the removal of heat into the third housing part.

A third preferred embodiment of the converter cell has on the said electrode assembly first and second said current conducting devices of differing polarity, and the said cell housing. The electrode assembly is designed as a flat electrode coil, or an electrode stack, in each case with at least one electrode of first and second polarity.

The current connection devices each have one of the said contact sections and at least one or a plurality of the said collector tabs, wherein the contact sections serve to provide the electrical connection with the functional device, in particular via their electrode connection sections. The first current conducting device, in particular its collector tab, is electrically connected with the electrode of first polarity. The second current conducting device, in particular its collector tab, is electrically connected with the electrode of second polarity.

The cell housing comprises the first housing part. The first housing part comprises the first load-bearing element, the second load-bearing element and at least one or a plurality of the said functional devices, each with at least one or a plurality of the said functional elements. The load-bearing elements each have a first polymer material, in particular one that is interpenetrated by fibres. The first load-bearing element demarcates the at least one of the said functional devices from the surroundings of the converter cell. The second load-bearing element demarcates the at least one of the said functional devices from the electrode assembly of the converter cell. The at least one functional device is arranged between the first and second load-bearing elements. The first load-bearing element, preferably also the second load-bearing element, is connected, in particular materially connected, with at least one of the functional devices, at least in certain sections. The first load-bearing element has one or two of the said pole contact openings, each of which exposes a section of the adjacent functional device to the surroundings of the converter cell. The second load-bearing element has one or two of the said contact openings, as a result of which the adjacent functional device is exposed in certain sections to the electrode assembly. In an edge section, the first housing part comprises the second polymer material, which encloses the edge section of the first housing part. The second polymer material also connects the edge section of the first housing part with the first current conducting device, preferably also with the second current conducting device, in a materially connected and/or gas-tight manner. The first current conducting device, preferably also the second current conducting device, extends out of the second polymer material into the cell housing in the direction of the electrode assembly. The first housing part preferably has an accommodation space, which at least partially accommodates the electrode assembly.

The at least one functional device is operationally connected, in particular electrically connected, with the electrode assembly. The at least one functional device has one, preferably two, of the said electrode connection sections, which serve to provide the electrical connection with the electrode assembly. The two current conducting devices each have one of the said contact sections, wherein the contact sections serve to provide the electrical connection with the at least one functional device, in particular via their electrode connection sections. The first electrode connection section of the at least one functional device and the contact section of the first current conducting device are electrically connected to each other, preferably materially connected, in particular in the section of the first contact opening. The second electrode connection section of the at least one functional device is preferably electrically connected with the contact section of the second current conducting device, preferably materially connected, in particular in the section of the second contact opening. Furthermore the at least one functional device includes one or two of the said pole contact sections, each of which is exposed to the surroundings through one of the said pole contact openings of the first load-bearing element. The pole contact sections of the at least one functional device are each electrically connected with their electrode connection sections. The functional device is preferably designed as a populated circuit board, in particular one that is flexible. It is particularly preferable for the functional device to have a cell control device.

The cell housing furthermore has the second housing part. The second housing part has the said first load-bearing element, preferably the said second load-bearing element, and preferably at least one of the said functional devices. Each first load-bearing element, preferably also each second load-bearing element, has a first polymer material, in particular one that is interpenetrated by fibres. The at least one functional device is preferably arranged between the first and second load-bearing elements. The load-bearing elements are preferably connected, in particular materially connected, with the at least one functional device, at least in certain sections. The first load-bearing element preferably has one of the said pole contact openings, which exposes a section of the adjacent functional device to the surroundings of the converter cell. The second load-bearing element preferably has one of the said contact openings, as a result of which the functional device is exposed in certain sections to the electrode assembly. The functional device preferably has one of the said electrode connection sections, which serves to provide the electrical connection with the electrode assembly, in particular via one of the said contact sections of the current conducting devices. The functional device preferably has one of the said pole contact sections, which is exposed to the surroundings through the pole contact opening of the first load-bearing element. The pole contact section of the functional device is preferably electrically connected with its electrode connection section. In an edge section the second housing part has the second polymer material, which preferably encloses the edge section of the second housing part. The second polymer material preferably connects the edge section of the second housing part and the second current conducting device in a materially connected and/or gas-tight manner. The second housing part preferably has an accommodation space, which at least partially accommodates the electrode assembly.

The said preferred embodiment offers the advantages, that:
the functional device is protected by the first load-bearing element from damaging influences from the surroundings of the converter cell.
any damaging consequences of vibrations occurring during operation on the functional device are counteracted.
the functional device is held in the cell housing in an essentially rigid manner.
the functional device remains on the converter cell, in particular in the event of an accident,
the current conducting devices can each be designed without a current collector.

In accordance with a first preferred development of the said preferred embodiment the at least one functional device of the first housing part has two of the said pole contact sections and two of the said electrode connection sections, each of differing polarity. The first load-bearing element of the first housing part has two of the said pole contact openings. The second load-bearing element of the first housing part has two of the said contact openings. The said preferred development offers the advantage that energy can be exchanged with the electrode assembly via the pole contact sections of the first housing part. The said preferred development offers the further advantage that the current conducting devices can be designed without a first section.

In accordance with a second preferred development of the said preferred embodiment the at least one functional device of the first housing part has one of the said pole contact sections and one of the said electrode connection sections. The first load-bearing element of the first housing part has one of the said pole contact openings. The second load-bearing element of the first housing part has one of the said contact openings. Furthermore the at least one functional device of the second housing part has one of the said pole contact sections and one of the said electrode connection sections. The first load-bearing element of the second housing part has one of the said pole contact openings. The second load-bearing element of the second housing part has one of the said contact openings. The said preferred development offers the advantage that energy can be exchanged with the electrode assembly via the pole contact sections of the first and second housing parts. The said preferred development offers the further advantage that the current conducting devices can be designed without a first section.

The said housing parts are preferably connected by means of the said hinged section, or by means of the frame, corresponding respectively to the third or fourth preferred developments of the first preferred embodiment of the converter cell.

A fourth preferred embodiment corresponds essentially to the first or second preferred embodiment, wherein the electrode assembly is designed as a converter assembly. At least one of the said functional devices of the said preferred embodiment has at least one, preferably two or three, of the said fluid passages. A fluid line that is not associated with the converter cell is connected with the said fluid passage, which line serves in particular for the supply or removal of one of the said process fluids. The said fluid passage is preferably designed essentially in the form of a pipe, and is materially connected, and/or connected in a gas-tight manner, with the first load-bearing layer. It is particularly preferable for the said fluid passage to extend out of the cell housing into the surroundings of the converter cell.

In accordance with a first preferred development of the said embodiment, the converter assembly is designed as a polymer electrolyte-fuel cell. The membrane conducts protons. H₂ serves as the fuel and is supplied to the negative electrode, which is provided with a noble metal as a catalyst, in particular with Pt. After ionisation the protons pass through the membrane to the positive electrode and there come into contact with the oxidising agent. Water is created as the educt.

In accordance with a second preferred development of the said embodiment, the converter assembly is characterised by the integration of a hydrogen reservoir and a miniaturised fuel cell into a unit. Here no peripheral components, such as a pressure reducer, a pressure regulator, or hydrogen lines, are required. The hydrogen is supplied to the fuel cell directly from the integrated reservoir. The quantity of the hydrogen supplied to the fuel cell is controlled via the material properties of the surface of the hydrogen reservoir, and also via the contact surface between the hydrogen reservoir and the fuel cell. In order to implement the fuel cell completely without active components, it is designed as a self-breathing system. The said preferred development offers great potential for miniaturisation.

In accordance with a third preferred development of the said embodiment the converter assembly is designed with an air cathode made from highly porous Al₂O₃, ZnO or SiC. The anode is made from a pressed Zn powder, a metal foam with inlaid Zn, or a ceramic, in particular SiC, with Zn components. The electrolyte and separator are designed as a non-woven fabric, or a porous ceramic with 30% KOH. The said preferred development is particularly suitable for high operating temperatures.

The housing parts are preferably connected by means of the said hinged section or by means of the said frame, corresponding respectively to the third or fourth preferred developments of the first preferred embodiment of the converter cell.

A battery preferably has at least two converter cells according to the invention, or their preferred forms of embodiment. Furthermore the battery has a battery controller and preferably a second short-range radio device. The second short-range radio device is preferably connected in terms of signals with one of the first short-range radio devices of one of the said converter cells.

It is particularly preferable for the second short-range radio device to be provided so as to transmit temporarily a predetermined first signal, whereupon a first of the said short-range radio devices responds with a predetermined signal. The said configuration offers the advantage that the functional capability of the converter cells of the battery can be interrogated by the second short-range radio device.

It is particularly preferable for the battery controller to be provided, after receipt of a predetermined second signal from one of the first said short-range radio devices of one of the converter cells, so as to connect the said converter cell by means of the second short-range radio device into the supply of one of the connected consumer loads. The said configuration offers the advantage that the replacement of a converter cell is simplified.

The at least two converter cells are preferably designed each with one of the said first and second layered sections of differing wall thickness. The said layered sections are aligned one upon another, such that between the first converter cell and the second converter cell, in particular between their cell housings, at least one passage is formed for a temperature-regulating medium. It is particularly preferable for the passage to run between one of the said first layered sections of the first converter cell and one of the said second layered sections of the second converter cell. The said configuration offers the advantage that the temperature-regulating medium, which flows along the passage, can exchange thermal energy with at least one of the said two converter cells, in particular for purposes of the removal of heat from at least one of the said two converter cells.

### A Method for the Manufacture of an Electrochemical Energy Converter Device

In what follows, a method according to the invention is described for the manufacture of an electrochemical energy converter device, hereinafter also referred to as a converter cell. In particular the converter cell is designed as described previously. The converter cell, manufactured in accordance with the said method, according to the invention, has one of the said electrode assemblys, at least one or two of the said current conducting devices, and one of the said cell housings with one of the said first housing parts, preferably also with one of the said second or third housing parts. The electrode assembly has at least two electrodes of differing polarity. At least two of the said current conducting devices are each fitted with an electrode of differing polarity. At least one or two of the said current conducting devices preferably comprises at least one or a plurality of collector tabs, particularly preferably one current collector each. At least one or two of the said current conducting devices each preferably has a contact section. The first housing part has a first load-bearing element, and at least one or a plurality of said functional devices, each with at least one or a plurality of said functional elements. The first load-bearing element faces towards the surroundings of the converter cell. The first load-bearing element includes a first polymer material, in particular one that is interpenetrated by fibres. The at least one functional device is connected, in particular materially connected, with the first load-bearing element, at least in certain sections. At least one of the said functional devices is operationally connected, preferably electrically connected, with the electrode assembly. The first housing part preferably has the second mounting element, which is preferably arranged between the functional devices and the electrode assembly, and particularly preferably is connected, in particular materially connected, with one of the said functional devices. The first housing part preferably has a second polymer material in an edge section. The manufacturing method according to the invention is characterised by at least one of the following steps:

(S1) Creating at least one or a plurality of the said functional devices, each with at least one or a plurality of the said functional elements, wherein at least one or two of the functional elements is preferably designed as an electrode connection section or as a pole contact section; preferably the subsequent supply of at least one or a plurality of the said functional devices to a first stock holding,
(S1′) Creating at least one or a plurality of the said functional devices with in each case at least one or a plurality of the said functional elements, wherein at least one or two of the said functional elements is preferably designed as an electrode connection section or as a pole contact section, wherein into at least one of the said functional devices is introduced: a foam, a voided structure, in particular a honeycomb structure, at least one void for a temperature-regulating medium, a filler with the ability to change its phase and/or a chemically reactive filler; preferably the subsequent supply of at least one or a plurality of the said functional devices to a first stock holding,
(S1″) Creating at least one or a plurality of the said functional devices with in each case at least one or a plurality of the said functional elements, wherein at least one or two of the said functional elements is preferably designed as an electrode connection section or as a pole contact section, wherein at least one or a plurality of the said functional devices is manufactured with a first layered section with a first wall thickness and a second layered section with a second wall thickness, wherein the fraction formed by the second wall thickness divided by the first wall thickness has a predetermined value less than 1, particularly preferably the first layered section has a lower density than the second layered section; preferably the subsequent supply of at least one or a plurality of the said functional devices to a first stock holding,
(S2) Preparing, preferably from a second stock holding, one of the said first load-bearing elements, which has a first polymer material, in particular one that is interpenetrated by fibres, which preferably has one or two of the said pole contact openings, wherein one or two of the said pole contact openings is adjacent in each case to one of the said pole contact sections, in particular after step S1,
(S2′) Placing one of the first load-bearing elements onto another of the said first load-bearing elements, in particular after step S2,
(S3) Placing at least one or a plurality of the said functional devices or functional modules, preferably from the first stock holding, onto the first load-bearing element, or onto another of the said functional devices, wherein at least one populated circuit board, in particular one that is flexible, is preferably placed as a functional device onto the first load-bearing element, wherein the circuit board particularly preferably has the functional elements in accordance with the first preferred configuration of the functional device, in particular after step S2,
(S4) Connecting, in particular materially connecting the first load-bearing element with at least one of the said functional devices, whereupon a layered composite is formed, preferably under the influence of heat, preferably by means of an isotactic or a continuous press, in particular after step S3,
(S5) Placing a second load-bearing element onto one of the said functional devices, preferably from a third stock holding, wherein the second load-bearing element has a first polymer material, in particular one that is interpenetrated by fibres, wherein the second load-bearing element preferably has one or two contact openings, in particular after step S3,
(S6) Connecting the second load-bearing element with one of the said functional devices, in particular with the adjacent functional device, preferably under the influence of heat, preferably by means of an isotactic or a continuous press, in particular after step S5,
(S7) Storing the layered composite in a fourth stock holding, in particular after step S4,
(S8) Taking the layered composite in particular from the fourth stock holding, wherein the layered composite has at least the first load-bearing element, one or a plurality of the said functional devices, in each case with at least one or a plurality of the said functional elements, and preferably the second load-bearing element, in particular after step S7,
(S9) Cutting to length of at least one essentially planar moulding blank from the layered composite, preferably with a parting device, in particular after step S8,
(S10) Heating the essentially planar moulding blank, preferably up to a working temperature that corresponds at least to the softening temperature of the first polymer material of the first load-bearing element, in particular in the processing device, in particular after step S9,
(S11) Supply the essentially planar moulding blank into a processing device, in particular into a moulding tool, in particular after step S10,
(S12) Inserting at least one or a plurality of the said current conducting devices, preferably insertion of at least one or a plurality of the said current collectors, into the processing device, in particular into the moulding tool, in particular to the essentially planar moulding blank, in particular after step S11,
(S13) Forming an accommodation space for the electrode assembly in the moulding blank, in particular in the processing device, in particular by means of deformation of the, in particular heated, moulding blank with a body, wherein the accommodation space is matched to the shape of the electrode assembly, which preferably corresponds essentially to the shape of the electrode assembly, which particularly preferably is created by closing the moulding tool, in particular after step S12,
(S14) Supplying a second polymer material, in particular one that is able to flow, preferably under the influence of heat and preferably with a pressure differential between the ambient air pressure and the pressure on the moulding blank, into the processing device, in particular into the moulding tool, wherein the second polymer material is arranged in the edge section of the moulding blank, in particular at a working temperature that corresponds at least to the softening temperature of the second polymer material, wherein in each of the said contact sections at least one or two of the said current conducting devices preferably remain free, in particular after one of the steps S10, S11, S12, or S13,
(S15) Strengthening the deformed moulding blank, preferably by cooling it down to an extraction temperature, which in particular lies below the softening temperature of the first polymer material, which in particular lies below the softening temperature of the second polymer material, in particular after step S14,
(S16) Extracting the, in particular deformed, moulding blank, hereinafter also referred to as the first housing part, from the processing device, in particular at an extraction temperature that lies below the softening temperature of the first polymer material, in particular after one of the steps S14 or S15,
(S17) Preparing the first housing part, i.e. the, in particular deformed, moulding blank, preferably in a processing device, which serves in particular to form the cell housing around the electrode assembly, in particular after step S16,
(S18) Electrically connecting, in particular by materially connecting at least one or a plurality of the said collector tabs with at least one or a plurality of the said electrodes of the electrode assembly, in particular by means of a joining method, preferably by means of a friction welding method, particularly preferably by means of ultrasonic welding, in particular after step S17 or S19,
(S19) Supplying the electrode assembly, which preferably has at least one or a plurality of the said collector tabs, to the first housing part, preferably into the processing device, in particular the inserting of the electrode assembly into the accommodation space of the first housing part, in particular after step S17,
(S20) Electrically connecting the electrode assembly with at least one or a plurality of the said current conducting devices, in particular by means of a joining method, preferably by means of a friction welding method, particularly preferably by means of ultrasonic welding, in particular after step S19,
(S21) Electrically connecting at least one or a plurality of the said collector tabs with one of the said current collectors, which are associated with the same current conducting device, in particular by means of a joining method, preferably by means of a friction welding method, particularly preferably by means of ultrasonic welding, in particular after step S19,
(S22) Electrically connecting of the contact section of at least one or a plurality of the said current conducting devices with at least one or a plurality of the said electrode connection sections of at least one of the said functional devices of the first housing part, in particular in the section of one of the said contact openings of the second load-bearing element of the first housing part, in particular by means of a joining method, preferably by means of a friction welding method, particularly preferably by means of ultrasonic welding, in particular after step S11, in particular before step S26,
(S23) Bringing the second housing part to the first housing part, wherein the second housing part preferably has the second polymer material in an edge section, in particular after step S22,
(S24) Bringing the third housing part to the first housing part, wherein a first heat transfer section of the third housing part is preferably arranged adjacent to the electrode assembly, particularly preferably is brought into thermal contact with the electrode assembly, in particular after step S22,
(S25) Heating in particular the edge section of in particular the first housing part to a working temperature that corresponds at least to the softening temperature of the second polymer material,
(S26) Connecting, in particular materially connecting, the second housing part or the third housing part with the first housing part, in particular at a working temperature that corresponds at least to the softening temperature of the second polymer material, wherein an edge section of the first housing part is preferably connected with the second housing part or the third housing part, in particular after step S25,
(S26′) Connecting, in particular materially connecting, the second housing part or the third housing part with the first housing part, in particular with the deployment of a sealant or an adhesive, wherein an edge section of the first housing part is preferably connected with the second housing part or the third housing part, in particular after step S25,
(S26″) Connecting, in particular materially connecting, the second housing part or the third housing part with the first housing part, preferably with the supply of a second polymer material, in particular one that is able to flow, preferably under the influence of heat and with a pressure differential relative to the surroundings of the processing device, in particular into the moulding tool, wherein the second polymer material is arranged in the edge section of the at least one housing part, in particular at a temperature that corresponds at least to the softening temperature of the second polymer material, wherein in each of the said contact sections at least one or two of the said current conducting devices preferably remain free, wherein an edge section of the first housing part is preferably connected with the second housing part or the third housing part, in particular after step S25,
(S27) Bringing together a plurality of the said functional elements into one of the said functional devices, as a result of which in particular a functional module is formed, in particular before step S3,
(S28) Lowering of the air pressure in the surroundings of the first housing part, in particular before step S26, whereupon the higher normal pressure in the surroundings of the cell housing, closed after step S26, causes a frictional force between cell housing and electrode assembly, which counters any undesirable relative movement between cell housing and electrode assembly.

In the context of the invention, a pressure differential relative to the surroundings of the processing device in step S26″ is understood to mean that the second polymer material, when supplied into the processing device, has a higher static pressure than the static pressure in the processing device. In accordance with a preferred configuration of step S26″ the second polymer material is subjected to an over-pressure relative to the surroundings of the processing device. In accordance with a further preferred configuration of step S26″ an under-pressure is present relative to the surroundings of the processing device in the section of the housing parts inserted into the processing device. Both pressure differentials serve to aid the supply of the second polymer material into the processing device. Both configurations offer the advantage that the filling of the sections of the processing device provided for the second polymer material is improved during the connection of the inserted housing parts.

The manufacturing method according to the invention offers the advantage that the cell housing, i.e. its first housing part, can be manufactured with a predetermined bending stiffness and/or a predetermined capability for energy absorption with regard to a foreign body from the surroundings impacting onto the converter cell, as a result of which, in particular, the mechanical robustness of the converter cell is improved. For this purpose step S2 is preferably executed several times before step S4, whereupon a plurality of first load-bearing elements are connected with the functional device to form the layered composite, i.e. the moulding blank.

The manufacturing method according to the invention offers the advantage that the cell housing, i.e. its first housing part, which within the operating temperature range has a predetermined bending stiffness and/or a predetermined capability for energy absorption with regard to a foreign body from the surroundings impacting onto the converter cell, can be manufactured at the working temperature with a lower expenditure of energy.

The manufacturing method according to the invention offers the advantage that the first load-bearing element improves the cohesiveness of the functional device, as a result of which the robustness of the converter cell with respect to vibrations, i.e. the functional capability of the converter cell in the presence of vibrations, are improved.

The manufacturing method according to the invention offers the advantage that, in particular in contrast to converter cells with a film-type cell housing, the need for separate stiffening components can be avoided.

The manufacturing method according to the invention offers the advantage that, after formation of the functional device, the layered composite and/or the first housing part, the later production steps are simplified. In this manner manufacturing costs are saved. The manufacturing method according to the invention offers the further advantage that the yield and quality of the manufacture are improved.

The manufacturing method according to the invention offers the advantage that the cell housing can be adapted simply and cost-effectively to electrode assemblys of differing nominal charge capacities, in particular in that the accommodation space in the first housing part need only be manufactured immediately before the insertion of the electrode assembly. In this manner storage costs can be reduced.

### Preferred Configurations of the Above-Cited Method According to the Invention for the Manufacture of a Converter Cell

A first preferred configuration of the above-cited method, according to the invention, for the manufacture of a converter cell, in particular for the closure of the cell housing around the electrode assembly, is characterised by the steps:
S17, S19, S20, S23 and S26, wherein the cell housing comprises one of the said second housing parts, or
S17, S19, S20, S24 and S26, wherein the cell housing comprises one of the said third housing parts.

The said preferred configuration of the method offers the advantage that at least one or a plurality of the said functional devices of the first housing part are arranged within the cell housing, in particular in a protected manner.

The method preferably also includes step S25. The said preferred configuration offers the advantage that the materially connected connection of the heated edge section with the second polymer material is improved.

Step S26 is preferably replaced by step S26′. The said preferred configuration offers the advantage that the connection of the said housing part can be undertaken at a temperature below the softening temperature of the first or second polymer material, particularly preferably at room temperature, as a result of which energy can be saved.

Step S26 is preferably replaced by step S26″. The said preferred configuration offers the advantage that the filling of the sections of the processing device provided for the second polymer material is improved during the connection of the inserted housing parts.

A second preferred configuration of the above-cited method according to the invention for the manufacture of a converter cell, in particular for the manufacture of a first housing part, is characterised by the steps: S11, S12, S14, S15, S16. The said configuration of the method preferably has step S10 for purposes of heating the moulding blank. The said configuration of the method preferably has step S13 for purposes of forming the accommodation space. The said preferred configuration of the method offers the advantage that at least one or a plurality of the said current conducting devices are enclosed by the second polymer material, in particular enclosed in a gas-tight manner, whereby in particular any exchange of substances between the interior of the cell housing and the surroundings of the converter cell is counteracted.

A third preferred configuration of the above-cited method according to the invention for the manufacture of a converter cell, in particular for the manufacture of a layered composite, wherein the layered composite has the first load-bearing element, at least one or a plurality of the said functional devices, and preferably the second load-bearing element, is characterised by the steps: S2, S3, S4. The said preferred configuration of the method offers the advantage that a connection, in particular a material connection, is created between the first load-bearing element and at least one of the said functional devices, as a result of which the cohesiveness of the said functional device is improved, in particular in the event of impacts. In step S3 at least one populated circuit board, in particular one that is flexible, is preferably placed onto the first load-bearing element as a functional device, or a functional module. Here the said circuit board has the functional elements in accordance with the first preferred configuration of the functional device. The said preferred configuration of the method offers the advantage that in the functional device, which is connected with the first load-bearing element, i.e. in particular is a captive part of the cell housing, numerous functions for controlling and/or monitoring the electrode assembly can be implemented.

The said configuration of the method preferably also has the step S2′, in particular after step S2. Here two first load-bearing layers are placed one upon another. The said preferred configuration offers the advantage that the wall thickness of the layered composite is increased, whereby an improved mechanical protection of an adjacent functional device is achieved.

The said configuration of the method preferably also has the steps S5 and S6. It is particularly preferable for step S5 to take place ahead of the simultaneously executed steps S4 and S6. The said preferred configuration offers the advantage that the housing part is stiffened with at least one of the said second load-bearing elements. The said preferred configuration offers the advantage that the said functional device is electrically insulated from the electrode assembly by means of the said second load-bearing element.

The said configuration of the method preferably, in particular before step S2, also has one of the steps S1, S1′ or S1″, particularly preferably with step S27. The said preferred configuration offers the advantage that the immediately preceding creation also of the functional device saves storage costs.

In accordance with a preferred development of the said preferred configuration the layered composite is manufactured with differing wall thicknesses. Here sections are manufactured for the first housing part, the second housing part, and for a hinged section. The hinged section is manufactured with a lower wall thickness than the sections for the housing parts, and preferably without a functional device, preferably while the sections for the housing parts contain additional load-bearing layers, or the hinged section has only one of the said first load-bearing layers. The hinged section is arranged between the section for the first housing part and the section for the second housing part. Later the moulding blank is cut to length such that at a first end it has the said section for the first housing part, at an opposite end it has the said section for the second housing part, and, positioned between them, the hinged section. The said development offers the advantage that the length of the edges to be sealed of the in particular quadrilateral cell housing, is reduced.

For the purpose of closing the cell housing, i.e. during the connection of the first housing part with the second housing part, the hinged section is brought to a working temperature above the softening temperature of the first polymer material, and is bent around such that the section for the first housing part lies opposite to the section for the second housing part. Subsequently, in particular after the housing parts have been connected around the electrode assembly, the hinged section is brought to an extraction temperature, in particular below the softening temperature of the first polymer material.

A fourth preferred configuration of the above-cited method, according to the invention, for the manufacture of a converter cell, in particular for the manufacture of the first preferred development of the first preferred embodiment of the cell housing, is characterised by the steps:
S11, wherein one of the said moulding blanks is supplied with one of the said functional devices to a processing device, wherein the said functional device includes at least one of the said electrode connection sections,
S12, wherein one or preferably two of the said current conducting devices, i.e. their current collectors, are brought to the said moulding blank in the moulding tool and are there arranged in the edge section of the moulding blank, i.e. of the imminent first housing part,
preferably S22, wherein at least one of the said contact sections of one of the said current conducting devices, i.e. one of the said current collectors, is electrically connected with at least one of the said electrode connection sections of the functional device,
S10, S13 and S14, wherein S10 is preferably executed ahead of S13 in time, and S13 is preferably executed simultaneously with S14, whereupon the moulding blank receives an accommodation space for the electrode assembly and the second polymer material is arranged in the edge section of the moulding blank such that the inserted current conducting devices, i.e. their current collectors, are enclosed by the second polymer material, in particular in a gas-tight manner,
S15, whereupon the softened first polymer material of the first load-bearing element regains strength and the resulting first housing part can be extracted from the moulding tool,
S18, for the purpose of equipping the electrode assembly with at least one or a plurality of the said collector tabs, wherein the collector tabs are connected with at least one of the said electrodes of first polarity, or with at least one of the said electrodes of second polarity,
S17 and S19, whereby the electrode assembly is supplied to the first housing part prepared in the processing device, and is preferably arranged in the accommodation space of the first housing part.
S21, wherein the said collector tabs, which are connected with the said electrodes of first polarity, and the said collector tabs, which are connected with the said electrodes of second polarity, are electrically connected with differing current collectors, in particular by means of a joining method,
S23, wherein the second housing part is inserted into the processing device up to the first housing part and the electrode assembly, wherein at least one of the said edge sections of the first housing part and at least one of the said edge sections of the second housing part are arranged adjacent to one another,
preferably S25, wherein in particular the edge section of in particular the first housing part is heated to a working temperature that corresponds at least to the softening temperature of the second polymer material,
S26, wherein in particular the edge sections, preferably the second polymer materials of the first housing part and the second housing part, are connected, in particular materially connected, to each other, in particular at a working temperature that corresponds at least to the softening temperature of the second polymer material.

Further advantages, features and possible applications of the present invention ensue from the following description in conjunction with the figures. In the figures:

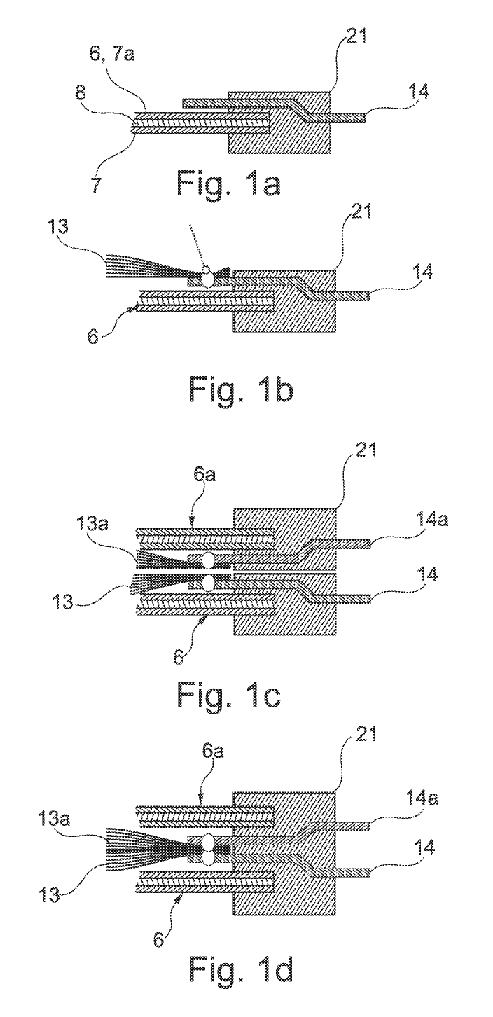

FIG. 1 shows schematic details of a preferred embodiment of an electrochemical energy converter device according to the invention,

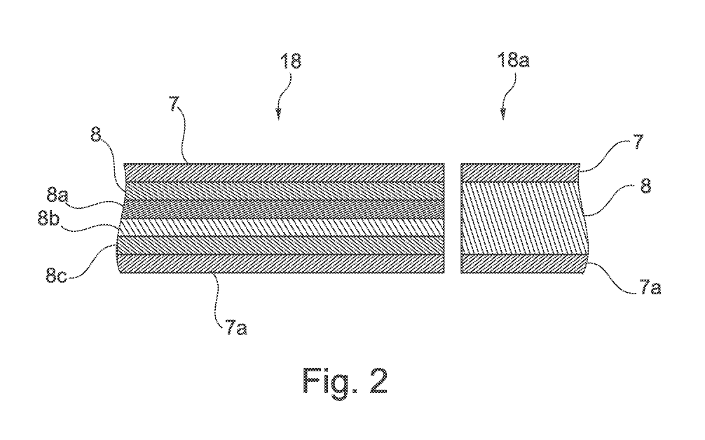

FIG. 2 shows schematically two differing layered composites for first housing parts,

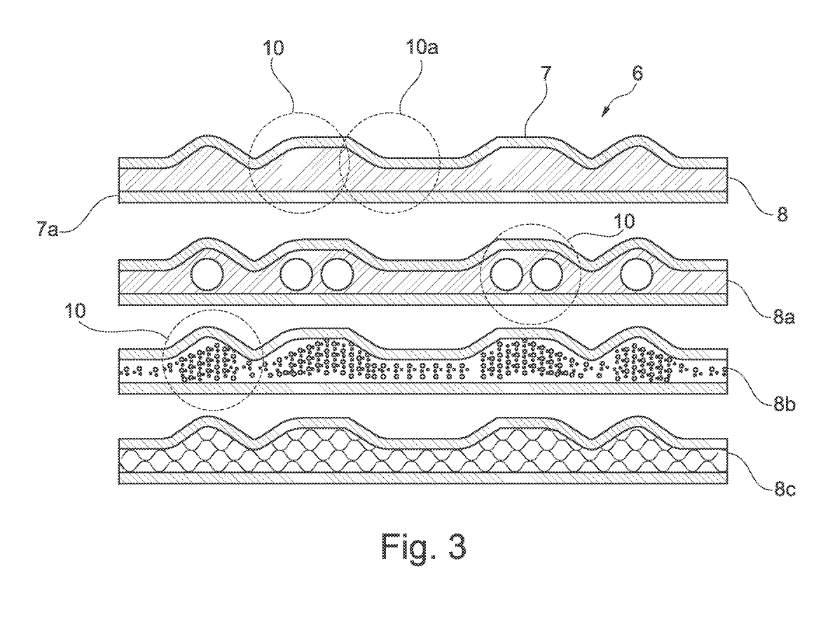

FIG. 3 shows schematic sections through first housing parts with differing functional elements, i.e. first and second layered sections,

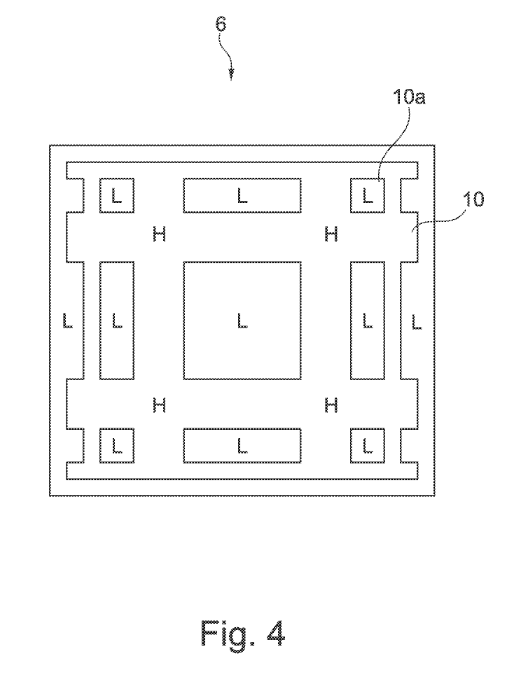

FIG. 4 shows a schematic view of a first housing part with first and second layered sections

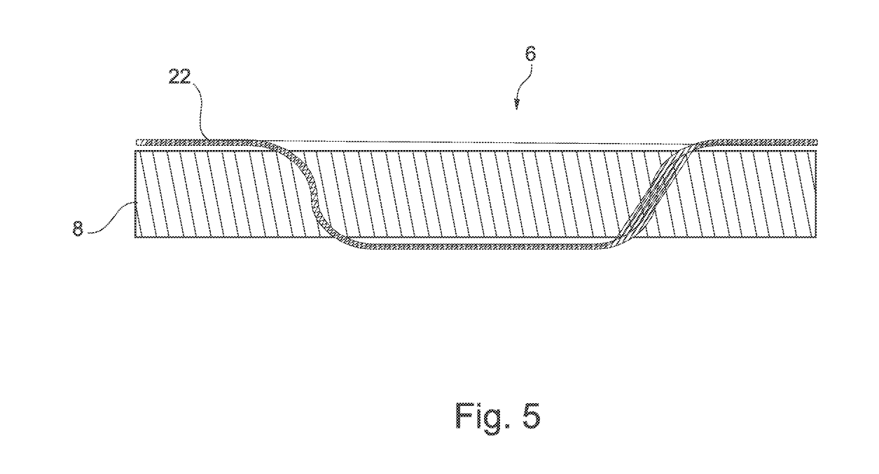

FIG. 5 shows schematically a section through a first housing part with a metallic inlay;

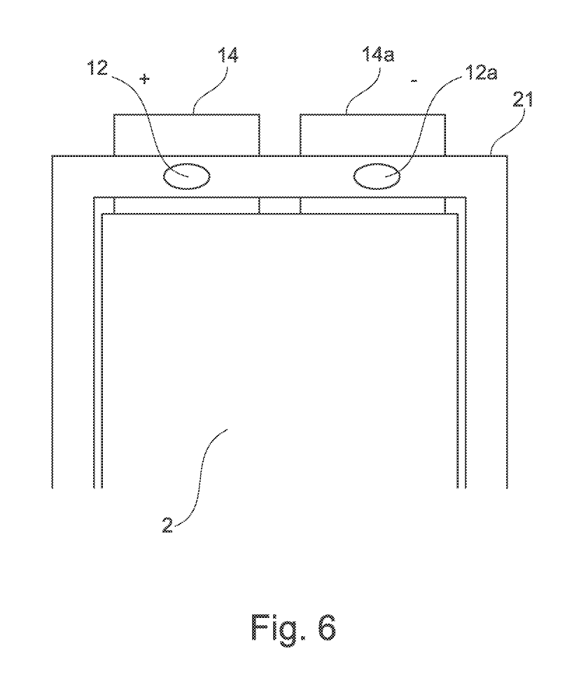

FIG. 6 shows a schematic section through a preferred embodiment of a converter cell,

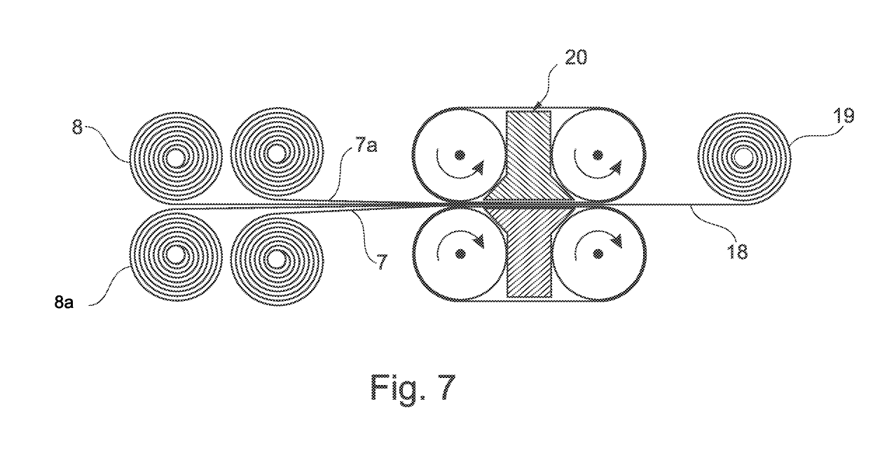

FIG. 7 shows schematically a processing device for the manufacture of a layered composite for a first housing part,

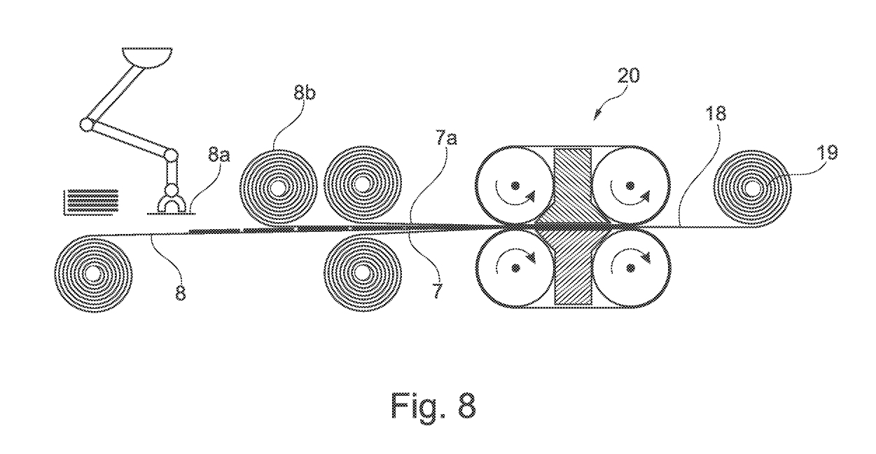

FIG. 8 shows schematically a processing device for the manufacture of a layered composite for a certain embodiment of a first housing part, wherein one of the said functional devices is designed as a populated, flexible circuit board,

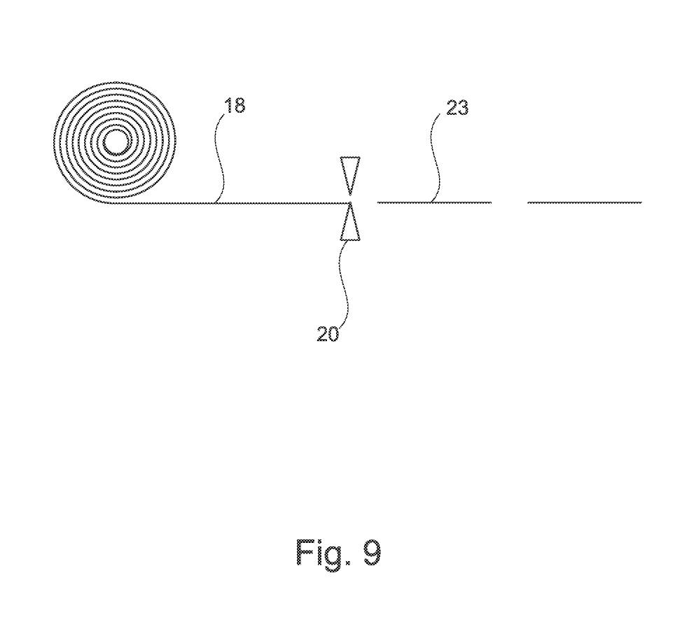

FIG. 9 shows schematically the cutting to length of moulding blanks from a prepared layered composite,

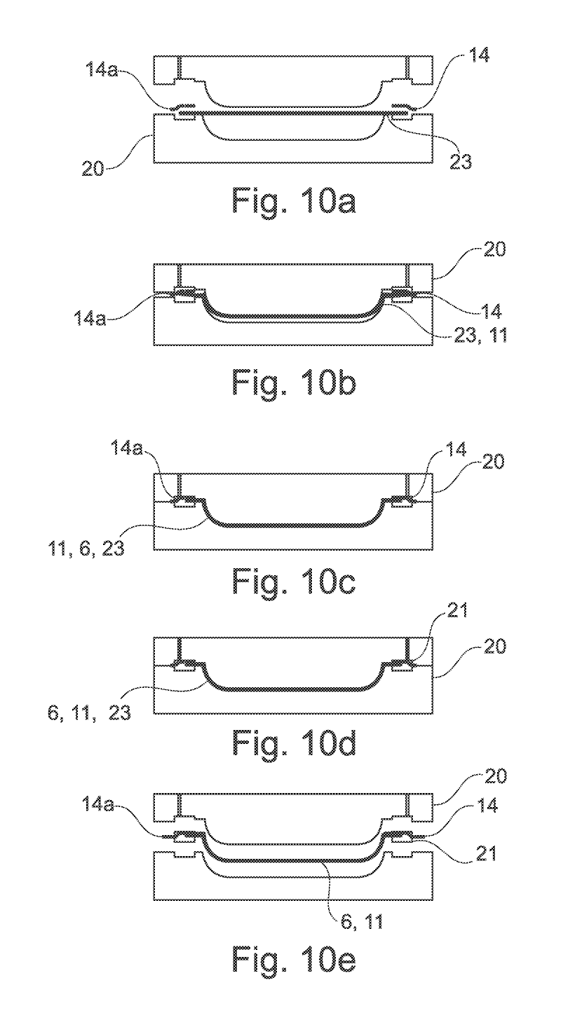

FIG. 10 shows schematically the manufacture of a first housing part from a moulding blank with the supply of a second polymer material in the edge section, with the formation of an accommodation space for an electrode assembly, with insert moulding of current collectors and the edge section of the moulded part blank, in a processing device,

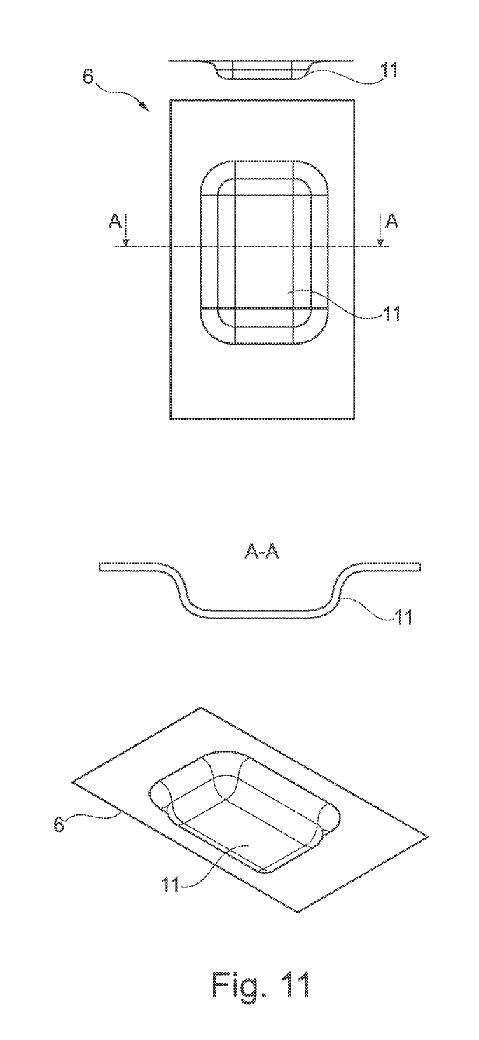

FIG. 11 shows various views and sections of a first housing part with accommodation space,

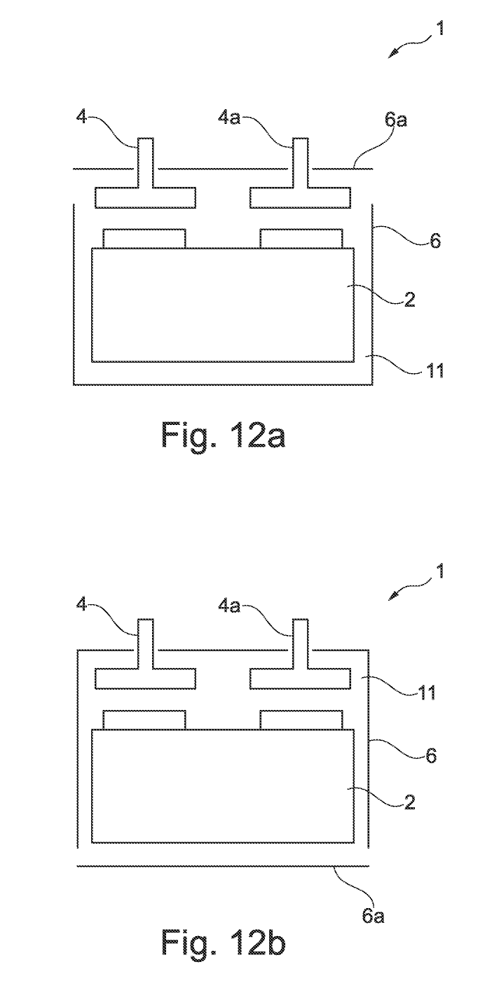

FIG. 12 shows schematically a converter cell with a two-part cell housing wherein the first housing part is designed as a tub, and the second housing part is designed as a cover.

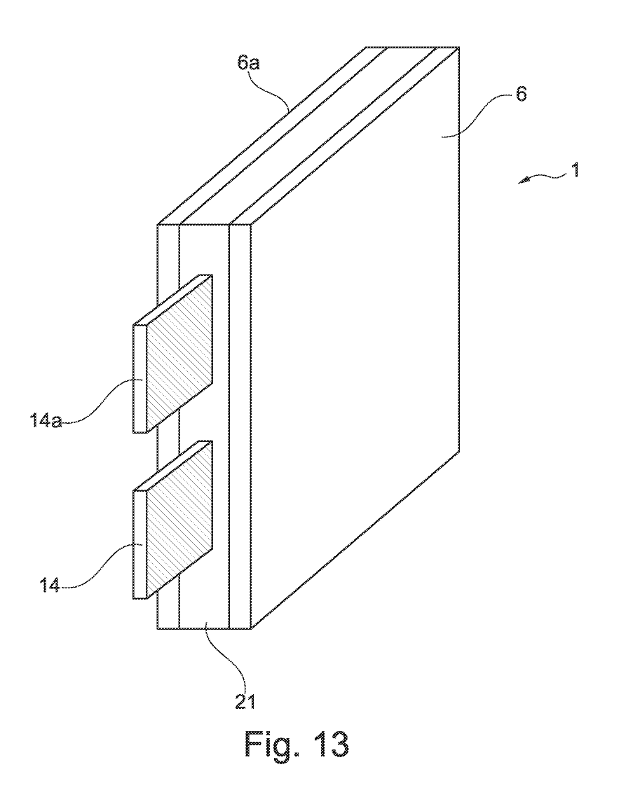

FIG. 13 shows schematically a converter cell with a two-part cell housing wherein the housing parts are spaced apart by a frame of a second polymer material.

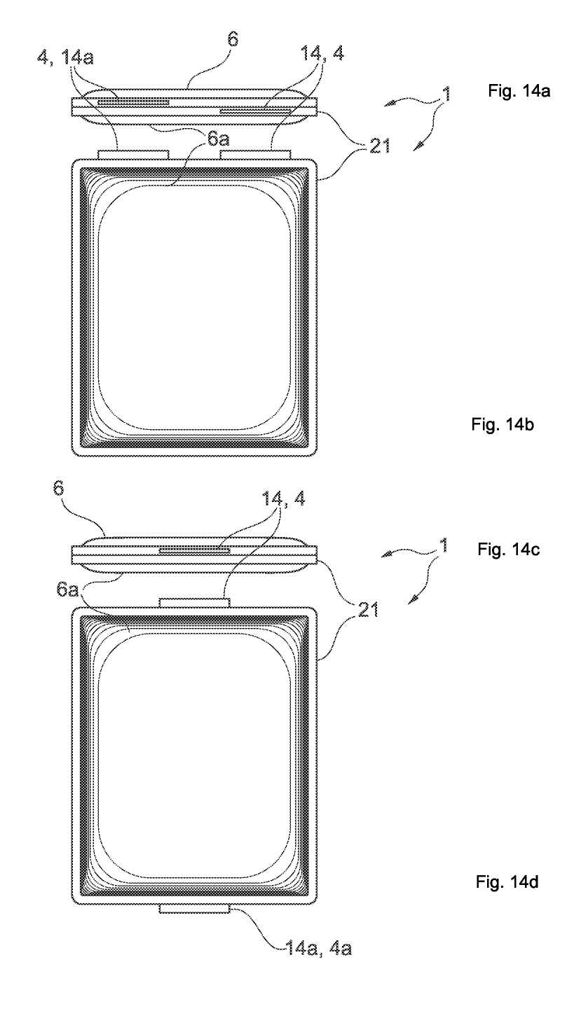

FIG. 14 shows schematically further preferred forms of embodiment of converter cells, in each case with a two-part housing, and in each case with two current collectors that extend into the surroundings of the converter cell,

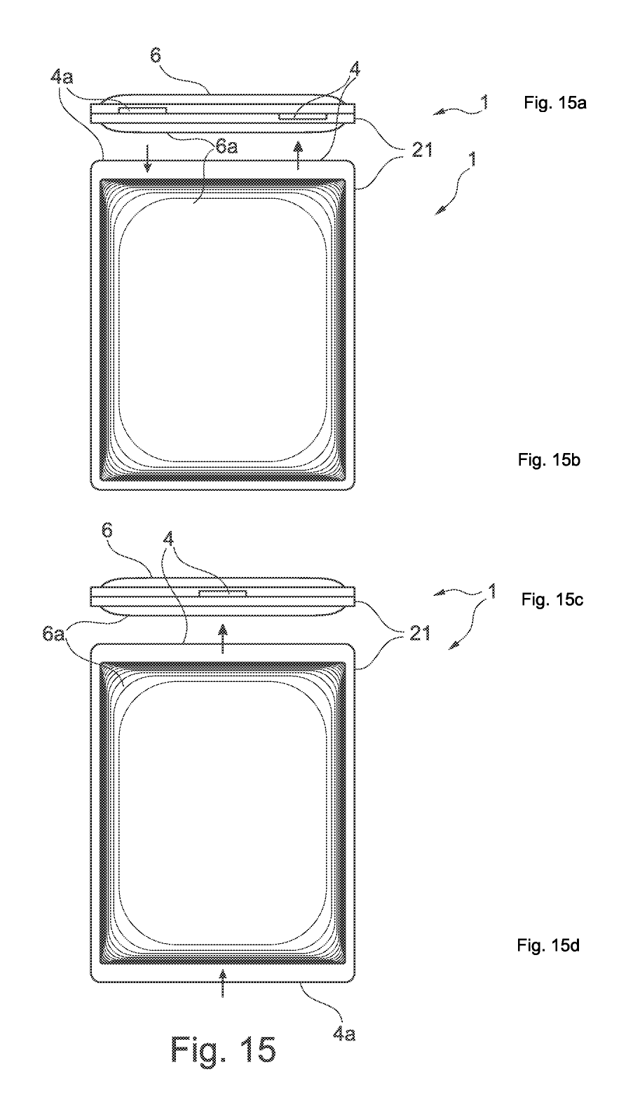

FIG. 15 shows schematically further preferred forms of embodiment of converter cells, in each case with a two-part housing and with current conducting devices that in each case terminate essentially on a cover surface of the cell housing,

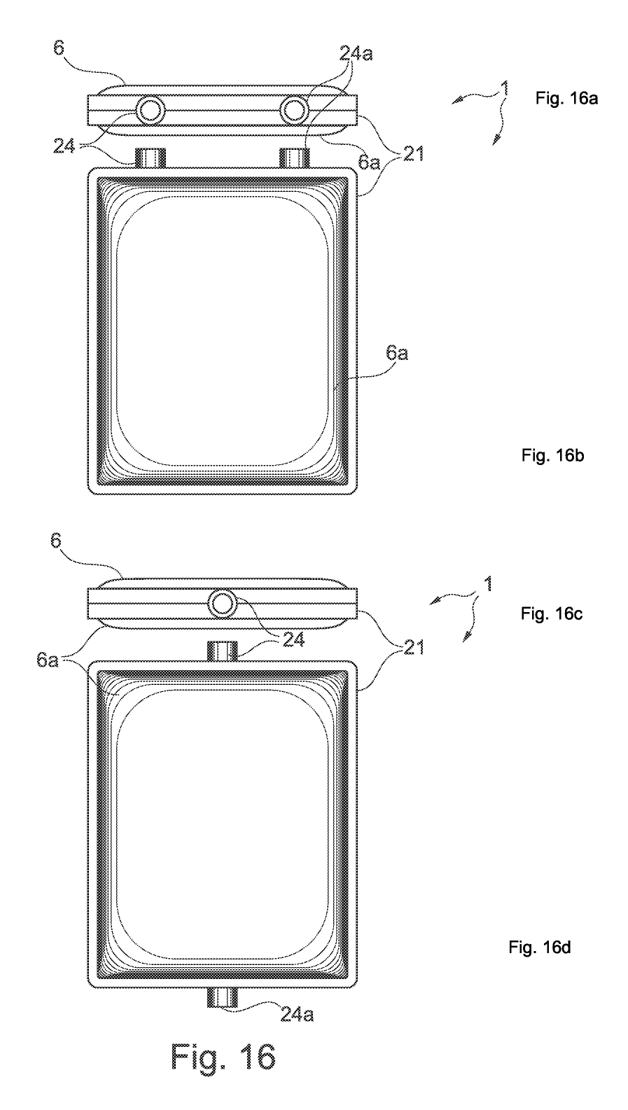

FIG. 16 shows schematically further preferred forms of embodiment of converter cells, in each case with a two-part housing, in each case with a converter assembly and two fluid passages.

FIG. 1 shows, in schematic form, details of a preferred embodiment of an electrochemical energy converter device according to the invention, i.e. a converter cell 1 with a first housing part 6. The first load-bearing element 7 and the second load-bearing element 7a are advantageously designed as load-bearing layers.

FIG. 1a shows that an edge section of the first housing part 6 is insert moulded with a second polymer material 21. A current collector 14 is insert moulded by the second polymer material 21, in particular in a gas-tight manner, and in particular is connected with the first housing part 6 in an essentially rigid manner. The first housing part 6 has the first load-bearing element 7, the second load-bearing element 7a and a functional device 8, wherein the functional device 8 spaces apart the load-bearing elements 7, 7a.

FIG. 1b shows that collector tabs 13 are welded onto the current collector 14. The collector tabs 13 are also electrically connected, in particular materially connected, with electrodes of a first polarity of an electrode assembly, not represented. The said electrical connection has been created after the electrode assembly, not represented, has been inserted into the first housing part 6, and before the cell housing is closed.

FIG. 1c shows the first housing part 6 and a second housing part 6a, whose edge sections are in each case insert moulded with the second polymer material 21. In each case one current collector 14, 14a is connected with one of the housing parts 6, 6a by means of the second polymer materials 21. Groups of collector tabs 13, 13a are welded onto the current collectors 14, 14a. The said groups of collector tabs 13, 13a are electrically connected with electrodes of differing polarity of the same electrode assembly, not represented. Thus the first current collector has a polarity that differs from that of the second current collector 14a. The cell housing is not yet closed.

FIG. 1d shows schematically a detail of the converter cell 1, after the cell housing 5 has been closed by the materially connected connection of the first housing part 6 with the second housing part 6a. Here the second polymer materials 21 of the edge sections of the housing parts 6, 6a have been fused to each other. The current collectors 14, 14a extend out of the cell housing 5. The current collectors 14, 14a also extend into the cell housing 5.

FIG. 2 shows schematically two layered composites 18, 18a for a first housing part. The first load-bearing element 7 and the second load-bearing element 7a are advantageously designed as load-bearing layers.

The layered composite 18 has two load-bearing elements 7, 7a, which surround, i.e. enclose, four functional devices 8, 8a, 8b, 8c. The individual functional devices fulfil differing tasks and for this purpose have differing functional elements. The second load-bearing element 7a has an arrangement of openings or holes, which enable a substance, in particular from the electrode assembly, not represented, to pass through to the fourth functional device 8c. The fourth functional device 8c has a pressure sensor, a thermocouple and a sensor for hydrogen fluoride, wherein the sensors are not represented. The third functional device 8b insulates the second functional device 8a from the electrode assembly, both chemically and electrically. However, the third functional device 8b has functional elements for the exchange of signals between the second functional device 8a and the named sensors. The second functional device 8a has a cell control device, not represented, which processes signals from the named sensors, and controls the operation of the electrode assembly, likewise not represented. The first functional device 8 has a cotton layer with alum as a flame-retarding filler, and serves to protect the second functional device 8a that lies underneath it.

The layered composite 18a has only one functional device 8. Here the pressure sensor, the thermocouple and the cell control device are part of the same functional device 8.

FIG. 3 shows schematic sections through differing configurations of the first housing part 6 with differing functional devices 8, 8a, 8b, 8c and also first and second layered sections 10, 10a. The functional device 8 is surrounded by the first load-bearing element 7 and the second load-bearing element 7a. The first load-bearing element 7 and the second load-bearing element 7a are advantageously designed as load-bearing layers. The functional device 8 has two layered sections 10, 10a, wherein the first layered section has a greater wall thickness than the second layered section 10a. The functional device 8a has a plurality of first layered sections 10, in which run passages for a temperature-regulating medium. The functional device 8b has a plurality of first layered sections 10, which are filled with a foam. For this purpose the functional device 8b is filled with an expandable filler, which forms voids when supplied with an activation energy. The functional device 8c has a voided structure, in particular a honeycomb structure, which serves to provide a weight saving together with an increased bending stiffness for the first housing part 6.

FIG. 4 shows a schematic view of a first housing part 6 with first layered sections 10 and second layered sections 10a of the functional device. The first layered sections 10, also marked with the letter “H”, have a greater wall thickness than the second layered sections 10a, also marked with the letter “L”. The first load-bearing element 7 and the second load-bearing element 7a are advantageously designed as load-bearing layers.

FIG. 5 shows schematically a section through a first housing part 6 with an in particular metallic inlay 22, which extends both into the functional device 8 and also externally from the said functional device. For simplicity the adjacent load-bearing elements are not represented. The inlay 22 serves to provide stiffening for the first housing part 6, in particular it serves to increase the bending stiffness of the first housing part 6. The inlay 22 is profiled for enhanced bending stiffness.

FIG. 6 shows a schematic section through a preferred embodiment of a converter cell. An electrode assembly 2 is inserted into a first housing part, and is electrically connected with current collectors 14, 14a. Not represented are collector tabs, which serve to provide the electrical connection between a current collector 14, 14a and an electrode of the electrode assembly 2. Both current collectors 14, 14a have contact sections 12, 12a. Of the first housing part only the second polymer material 21 is represented. Load-bearing elements and functional devices are not represented, in order that the contact sections 12, 12a can be better discerned. The contact sections 12, 12a extend out of the second polymer material 21 in the direction of the functional device, not represented. The contact sections 12, 12a serve to provide the electrical connection, in particular the supply, to the functional device, not represented.

FIG. 7 shows schematically a processing device 20 for the manufacture of a layered composite 18 for a first housing part. The first load-bearing element 7, the second load-bearing element 7a, and two functional devices 8, 8a, are unwound from various stock holdings. The first load-bearing element 7 and the second load-bearing element 7a are advantageously designed as load-bearing layers. The said layers are supplied to the processing device 20, here designed as a double belt press 20. In particular the layers that are laid one upon another are combined to each other in the double belt press 20 under the influence of heat to form a layered composite 18. The layered composite 18 is fed onto a stock holding 19.

FIG. 8 shows schematically a processing device 20 for the manufacture of a layered composite 18 for a preferred embodiment of a first housing part, with a plurality of functional devices, wherein one of the said functional devices is designed as a populated, flexible circuit board 8a. The first functional device 8 is firstly unwound. The circuit boards 8a are individually placed onto the first functional device 8 by a grab, preferably with a minimum separation distance between two circuit boards. A further functional device 8b and also two load-bearing elements 7, 7a are unwound. The first load-bearing element 7 and the second load-bearing element 7a are advantageously designed as load-bearing layers. The circuit board 8a is enclosed by the load-bearing elements 7, 7a before the layers are supplied to the double belt press 20. The layered composite 18 is created in the double belt press 20, in particular under the influence of heat. The layered composite 18 is fed onto a stock holding 19.

FIG. 9 shows schematically the cutting to length of moulding blanks 23 from a prepared layered composite 18, in particular by means of a parting device 20. If one of the functional devices is designed as a circuit board the layered composite 18 is parted between two such circuit boards.

FIG. 10 shows schematically the manufacture of a first housing part 6 from a moulding blank 23, with the supply of a second polymer material 21 into the edge section of the moulding blank 23, i.e. the first housing part 6, with the formation of an accommodation space 11 for an electrode assembly 2, with the insert moulding of current collectors 14, 14a and of the edge section of the moulding blank 23, in a processing device 20. Although not represented, the moulding blank 23 comprises the first load-bearing element, at least one of the said functional devices, and also the second load-bearing element. The first load-bearing element 7 and the second load-bearing element 7a are advantageously designed as load-bearing layers.

FIG. 10a shows the moulding blank 23 and also the current collectors 14, 14a, which are inserted into the processing device, here designed as a moulding tool 20. The two-part moulding tool is not yet closed. One part of the moulding tool 20 is designed with a depression, the other part of the moulding tool 20 is designed with a protrusion. The depression and protrusion serve to form an accommodation space in the moulding blank 23, i.e. the first housing part for the electrode assembly, not represented. Before the moulding tool 20, equipped with depression and protrusion, is closed the moulding blank 23 is heated to a working temperature that corresponds at least to the softening temperature of the first polymer material.

FIG. 10b shows the moulding tool 23 during the closing procedure, wherein the accommodation space 11 is formed in the moulding blank 23 by means of the depression and the protrusion. Here the moulding blank 23 has a working temperature that corresponds at least to the softening temperature of the first polymer material.

FIG. 10c shows the closed moulding tool 20. After plastic deformation, the inserted moulding blank 23 comprises the accommodation space 11. The current collectors 14, 14a are held in the moulding tool 20 in predetermined positions relative to the moulding blank 23, in particular in the edge section of the moulding blank 23. The moulding blank 23 preferably has a working temperature that corresponds at least to the softening temperature of the first polymer material, in particular such that the moulding blank 23 can enter into an intimate material connection with the second polymer material, not represented.

FIG. 10d shows the closed moulding tool 20, and also the moulding blank 23 inserted as in FIG. 10c, at a later point in time. Heated second polymer material 21 is supplied through two passages to the moulding tool 20. The second polymer material 21 fills voids provided in the moulding tool 20, which are arranged in edge sections of the moulding blank 23. The current collectors 14, 14a also extend through the voids. With the supply of the second polymer material 21, the edge sections of the moulding blank 23 and also the current collectors 14, 14a are insert moulded. The moulding blank 23 preferably has a working temperature that corresponds at least to the softening temperature of the first polymer material, in particular such that the moulding blank 23 can form close material connections with the second polymer material 21.

After the supply of the second polymer material 21 its temperature, and also the temperature of the moulded moulding blank 23 are lowered, such that they also fall below the softening temperature of the first polymer material. The first housing part 6 is then ready to be extracted.

FIG. 10e shows the opened moulding tool 20 and also the first housing part 6 that has been removed from the mould. The first housing part 6 has the two load-bearing elements, at least one of the functional devices, in the edge section the second polymer material 21, the accommodation space 11, and also the current collectors 14, 14a. After the extraction of the first housing part 6 the moulding tool 20 is ready for the manufacture of the next first housing part.

FIG. 11 shows various views and sections of a first housing part 6 with an accommodation space 11 for an electrode assembly.

FIG. 12 shows schematically a converter cell 1 with a two-part cell housing 5, wherein the first housing part 6 is designed as a tub, and the second housing part 6a is designed as a cover. The interior of the tub corresponds to the accommodation space 11. Not represented is the second polymer material, which is arranged in the edge sections of the housing parts 6, 6a. Two current conducting devices 4, 4a extend, at least in certain sections, through of one of the housing parts into the surroundings of the converter cell 1.

FIG. 12a shows that the current conducting devices 4, 4a are led through the second housing part 6a into the surroundings. The fact that the current conducting devices 4, 4a are connected with the second housing part 6a in a material connection and in particular in a gas-tight manner, is not represented.

FIG. 12b shows that the current conducting devices 4, 4a are led through the first housing part 6 into the surroundings. The fact that the current conducting devices 4, 4a are connected with the first housing part 6 in a material connection and in particular in a gas-tight manner, is not represented.

FIG. 13 shows schematically a converter cell 1 with a two-part cell housing 5, wherein the housing parts 6, 6a are spaced apart by means of a frame of the second polymer material 21. The electrode assembly, not represented, is accommodated by the frame. Thus the housing parts 6, 6a are in each case designed without an accommodation space. Two of the current conducting devices 14, 14a extend out of the frame 21 into the surroundings of the converter cell 1.

FIG. 14 shows schematically further preferred forms of embodiment of converter cells 1, in each case with a two-part cell housing 5, and in each case with two current collectors 14, 14a, which extend into the surroundings of the converter cell 1. Edge sections of the said housing parts 6, 6a are in each case surrounded by the second polymer material 21. The said edge sections are connected to each other in a material connection, in particular in a gas-tight manner. Thus the housing parts 6, 6a jointly form the cell housing around the electrode assembly, not represented. The current collectors 14, 14a extend from different housing parts 6, 6a, in particular in each case from the second polymer material 21, which in each case connects one of the said current collectors with one of the said housing parts in a gas-tight manner. The housing parts 6, 6a are in each case designed with an accommodation space. The two housing parts 6, 6a are advantageously of symmetrical design. In this manner storage costs are reduced.

FIGS. 14a and 14b show a converter cell 1, in which the fluid passages 14, 14a extend out of the cell housing in the same direction.

FIGS. 14c and 14d show a converter cell 1, in which the fluid passages 14, 14a extend out of the cell housing in opposite directions.

FIG. 15 shows schematically further preferred forms of embodiment of converter cells 1, in each case with a two-part cell housing 5 and with current conducting devices 4, 4a, which each terminate essentially on a cover surface of the cell housing 5. Edge sections of the said housing parts 6, 6a are in each case surrounded by the second polymer material 21. The said edge sections are connected to each other in a material connection, in particular in a gas-tight manner. Thus the housing parts 6, 6a jointly form the cell housing around the electrode assembly, not represented. The current conducting devices 4, 4a are arranged in different housing parts 6, 6a, in particular in each case in the second polymer material 21, which each connects one of the said current conducting devices with each of the said housing parts in a gas-tight manner. The current conducting devices 4, 4a terminate on cover surfaces of different housing parts 6, 6a. The housing parts 6, 6a are each designed with an accommodation space. The two housing parts 6, 6a are advantageously of symmetrical design. In this manner storage costs are reduced.

FIGS. 15a and 15b show a converter cell 1, in which the current conducting devices 4, 4a extend in the same direction.

FIGS. 15c and 15d show a converter cell 1, in which the current conducting devices 4, 4a extend in opposite directions.

FIG. 16 shows schematically further preferred forms of embodiment of converter cells, in each case with a two-part cell housing 5, each with a converter assembly 2 and two fluid passages 24, 24a. Not represented are the current conducting devices of the converter cell 1. Edge sections of the said housing parts 6, 6a are in each case surrounded by the second polymer material 21. The said edge sections are materially connected to each other, in particular in a gas-tight manner. Thus the housing parts 6, 6a together form the cell housing which goes around the converter assembly 2, not represented. The fluid passages 24, 24a extend from the cell housing, in particular from the second polymer material, into the surroundings of the converter cell 1. The first fluid passage 24 serves to supply the fuel. The second fluid passage 24a serves both to supply the oxidising agent and also to remove the educt. For this purpose the second fluid passage 24a has a separating wall, not represented.

FIGS. 16a and 16b show a converter cell 1, whose fluid passages 24, 24a extend in the same direction.

FIGS. 16c and 16d show a converter cell 1, whose fluid passages 24, 24a extend in opposite directions.

### LIST OF REFERENCE NUMBERS

1 Converter cell
2 Electrode assembly, converter assembly
3, 3a Electrode
4, 4a Current conducting device
5 Cell housing
6, 6a, 6b Housing part
7, 7a Load-bearing element
8, 8a, 8b Functional device
9, 9a Functional element
10, 10a Layered section
11 Accommodation space
12, 12a Contact section
13 Collector tab
14, 14a Current collector
15, 15a Pole contact opening
16, 16a Pole contact section
17, 17a Contact opening
18 Layered composite
19 Stock holding
20 Processing device, moulding tool
21 Second polymer material, frame made from second polymer material
22 Inlay
23 Moulding blank
24, 24a Fluid passage

1. An electrochemical energy converter device, hereinafter also referred to as a converter cell (1), with at least
an in particular rechargeable electrode assembly (2), which is provided so as to make electrical energy available, at least temporarily, in particular to a consumer load, which has at least two electrodes (3, 3a) of differing polarity, which is preferably provided so as to convert chemical energy into electrical energy, at least temporarily, which is preferably provided so as to convert in particular supplied electrical energy into chemical energy, at least temporarily,
a current conducting device (4, 4a), which is provided so as to be electrically connected, preferably materially connected, with one of the electrodes (3, 3a) of the electrode assembly (2),
a cell housing (5) with a first housing part (6), wherein the cell housing (5) is provided so as to enclose the electrode assembly (2) at least in certain sections,
wherein the first housing part (6) has at least:
a functional device (8, 8a, 8b), which is provided so as to support the output of energy from the electrode assembly (2), in particular to a consumer load, which functional device is operationally connected with the electrode assembly (2), in particular for the collection of energy,
a first load-bearing element (7), which is provided so as to support the at least one functional device (8, 8a, 8b).

2. The electrochemical energy converter device in accordance with claim 1, characterised in that, the at least one functional device (8, 8a, 8b) has at least one functional element (9, 9a), wherein the at least one functional element (9, 9a) is operationally connected with the electrode assembly (2), in particular is electrically connected, wherein the at least one functional element (9, 9a) is preferably designed as:
a pole contact section (16, 16a), an electrode connection section, a conducting track, an opening, a voltage probe, a current probe, a temperature probe, a pressure sensor, a material sensor, a gas sensor, a fluid sensor, a location sensor, an acceleration sensor, a control device, an application-specific integrated circuit, a microprocessor, a switching device, a current interrupter, a current limiter, a discharge resistance, a pressure release device, a fluid passage, a positioning device, an actuator, a data storage device, a bleeper, a light-emitting diode, an infrared interface, a GSM module, a first short-range radio device or transponder.

3. The converter cell (1) in accordance claim 1, characterised in that, the at least one functional device (8, 8a, 8b) at least:
is designed to be partially porous, particularly preferably with a foam, and/or
has a voided structure in certain sections, in particular a honeycomb structure, and/or
has a void for a temperature-regulating medium, and/or
has in certain sections an expandable filler, which is provided so as to form voids, in particular when supplied with an activation energy, or when triggered by a functional element (9, 9a), and/or
has in certain sections a filler with the ability to undergo a phase change (PCM), in particular within the predetermined operating temperature range of the converter cell (1), and/or
has in certain sections a chemically reactive filler, which is preferably provided so as to bind chemically a substance, in particular from the electrode assembly (2), particularly preferably after the release of the substance from the electrode assembly (2), and/or
has a first layered section (10) with a first wall thickness (thick) and a second layered section (10a) with a second wall thickness (thin), wherein the fraction formed by the second wall thickness divided by the first wall thickness has a predetermined value that is less than 1, wherein the first layered section (10) preferably has a lower density than the second layered section (10a).

4. The converter cell (1) in accordance with claim 1, whose cell housing (5) has a second housing part (6a), wherein the second housing part (6a)
is provided so as to be connected, in particular materially connected, at least in certain sections, with the first housing part (6),
is provided so as to form with the first housing part (6) the cell housing (5) of the converter cell (1),
preferably has at least one functional device (8, 8a, 8b), which is provided so as to support the output of energy, in particular to a consumer load, which is operationally connected with the electrode assembly (2), in particular for the collection of energy.

5. The converter cell (1) in accordance with claim 1, characterised in that, the first housing part (6) and/or the second housing part (6a)
has an accommodation space (11), which is provided so as to accommodate the electrode assembly (2), at least partially, and/or
has a second load-bearing element (7a), which in particular is arranged adjacent to the functional device (8) and faces towards the electrode assembly (2), which preferably has a first polymer material, in particular one that is interpenetrated by fibres, in particular for purposes of stiffening the second load-bearing element (7a), wherein preferably the second loadbearing element (7a) has a contact opening (17, 17a), and/or
in an edge section of the housing part has a second polymer material (21), wherein the second polymer material (21) serves to provide the in particular materially connected connection with another housing part (6, 6a), wherein the second polymer material (21) is preferably designed as a thermoplastic.

6. The converter cell (1) in accordance with claim 1, whose cell housing (5) has an essentially plate-shaped third housing part (6b), wherein the third housing part (6b)
is provided so as to be connected, in particular materially connected, together with the first housing part (6), to the cell housing (5), at least in certain sections, and/or
compared with the first housing part (6) has an enhanced thermal conductivity; preferably comprises a metal, particularly preferably aluminium and/or copper, and/or
has a first heat transfer section, which is provided so as to exchange thermal energy with the electrode assembly (2), and/or
preferably has a second heat transfer section, which is provided so as to exchange thermal energy with a temperature-regulating device that is not associated with one of the converter cells (1).

7. The converter cell (1) in accordance with claim 1, characterised in that, the at least one current conducting device (4, 4a) has a contact section (12, 12a), wherein the contact section (12, 12a)
serves to provide electrical contact, in particular the electrical supply to the functional device (8), and/or
is preferably arranged in an edge section of the first housing part (6), and/or
preferably extends in the direction of the functional device (8), and/or
is preferably designed by means of a forming method, is particularly preferably designed as a hump or projection.

8. The converter cell (1) in accordance with claim 1, characterised in that, at least one of the said current conducting devices (4, 4a)
has at least one collector tab (13, 13a), which is connected, preferably materially connected, with one of the electrodes (3, 3a) of the electrode assembly (2),
preferably has a current collector (14, 14a), which extends at least partially into the interior of the cell housing (5), which particularly preferably extends at least partially out of the cell housing (5) into the surroundings of the converter cell (1), which is connected, in particular materially connected, with the at least one collector tab (13, 13a).

9. The converter cell (1) in accordance with claim 1, characterised in that,
at least one of the said functional devices (8, 8a, 8b) is arranged between the first loadbearing element (7) and the second load-bearing element (7a), and is preferably connected, in particular materially connected, with the first load-bearing element (7) and the second loadbearing element (7a), at least in certain sections, the first load-bearing element (7) has at least one pole contact opening (15, 15a), which in particular makes a section of the adjacent functional device (8) accessible from the surroundings of the converter cell (1), in particular such that it can be electrically contacted,
at least one of the said functional devices (8, 8a, 8b) has at least one of the said pole contact sections (16, 16a), in particular in the section of the at least one pole contact opening (15, 15a), which has the potential of one of the electrodes (3, 3a) of the electrode assembly (2), which preferably serves to provide the electrical connection of the said electrode (3, 3a) with another converter cell (1) or with a consumer load,
the second load-bearing element (7a) adjacent to the contact section (12, 12a) of the current conducting device (4, 4a) has a contact opening (17, 17a),
the functional device (8, 8a, 8b), in particular in the section of the contact opening (17, 17a), has as a functional element (9, 9a) the electrode connection section, which in particular faces towards the current conducting device (4, 4a), preferably its contact section (12, 12a),
an electrical connection is formed between the current conducting device (4, 4a), in particular its contact section (12, 12a), and the functional device (8), in particular for purposes of the electrical supply of the functional device (8), i.e. of the at least one functional element (9, 9a), by the electrode assembly (2).

10. The converter cell (1) in accordance with claim 1, characterised by a housing module with the first housing part (6) and at least one of the said current conducting devices (4, 4a), preferably two of the said current conducting devices (4, 4a), which are connected with electrodes (3, 3a) of differing polarity, wherein
the first housing part (6) has an in particular materially connected layered composite (18, 18a) of at least the first load-bearing element (7), at least one functional device (8) with at least one functional element (9, 9a), and the second load-bearing element (7a),
the first housing part (6) has, in particular in the edge section, a second polymer material (21), wherein the edge section is preferably enclosed by the second polymer material (21), at least in certain sections,
the first housing part (6) has an accommodation space (11), wherein the accommodation space (11) is provided so as to accommodate the electrode assembly (2), at least partially,
at least one of the said current conducting devices (4, 4a) has the contact section (12, 12a), wherein the contact section (12, 12a) is arranged in the edge section of the first housing part (6), preferably in the second polymer material (21),
the second load-bearing element (7a) in the contact section (12, 12a) of at least one of the said current conducting device (4, 4a) has the contact opening (17, 17a),
the contact section (12, 12a) is in particular electrically connected through the contact opening (17, 17a) with the functional device (8, 8a, 8b), in particular with its electrode connection section (9, 9a).

11. The converter cell (1) in accordance with claim 1, characterised in that,
the at least one of the said functional devices (8, 8a, 8b) has one of the said cell control devices (9b) and at least one of the said measurement probes (9c),
the at least one measurement probe (9c) is provided so as to register an operating parameter of the converter cell (1), in particular of the electrode assembly (2), and to make it available to the cell control device (9b),
the cell control device (9c) is provided so as to control at least one operating procedure of the converter cell (1), in particular the charging and/or discharging of the electrode assembly (2), preferably to monitor an operating state of the converter cell (1).

12. The converter cell (1) in accordance with claim 1, characterised by
preferably a nominal charge capacity of at least 10 Ah, and/or
a nominal current of at least 50 A, preferably of at least 100 A, and/or
a nominal voltage of at least 3.5 V, and/or
an operating temperature range of −40° C. to +100° C., and/or
preferably a gravimetric energy density of at least 50 Wh/kg.

13. A secondary battery with at least two converter cells (1) in accordance with claim 1, with a battery controller and preferably with a second short-range radio device.

14. A method for the manufacture of an electrochemical energy converter device, in particular in accordance with one of the claim 1, wherein the electrochemical energy converter device, hereinafter also referred to as a converter cell (1), has at least:
one electrode assembly (2) with at least two electrodes (3, 3a) of differing polarity,
at least one or two current conducting devices (4, 4a), wherein the first current conducting device (4) is connected with the electrode of first polarity (3), and the second current conducting device (4a) is connected with the electrode of second polarity (3a), at least one of the said current conducting devices (4, 4a) preferably has at least one collector tab (13, 13a), particularly preferably a current collector (14, 14a), at least one of the said current conducting devices (4, 4a) preferably has a contact section (12, 12a),
one cell housing (5) with a first housing part (6), preferably also a second housing part (7a), or a third housing part (7b), wherein the first housing part (6) has a first load-bearing element (7) and at least one functional device (8, 8a, 8b) with at least one functional element (9, 9a, 9b, 9c), wherein the first load-bearing element (7) serves to support the at least one functional device (8, 8a, 8b), wherein the first loadbearing element (7) has a first polymer material, and preferably a fibrous material, wherein the at least one functional device (8, 8a, 8b) is connected, in particular materially connected, with the first load-bearing element (7), at least in certain sections, wherein at least one of the functional devices (8, 8a, 8b) is operationally connected, preferably electrically connected, with the electrode assembly (2), wherein the first housing part (6) preferably has a second load-bearing element (7a), which is arranged between the at least one functional device (8, 8a, 8b) and the electrode assembly (2), which particularly preferably is connected, in particular materially connected, with one of the said functional devices (8, 8a, 8b), wherein the first housing part (6) preferably has a second polymer material (21) in an edge section,
wherein the method serves in particular for purposes of closing the cell housing (5) around the electrode assembly (2), characterised by the following steps:
(S17) Preparing the first housing part (6), i.e. of the in particular deformed moulding blank (23), preferably in a processing device (20), which serves in particular for purposes of forming the cell housing (6) around the electrode assembly (2),
(S19) Supplying the electrode assembly (2), which preferably has at least one or a plurality of said collector tabs (13, 13a), to the first housing part (6), preferably into the processing device (20), in particular the insertion of the electrode assembly (2) into the accommodation space (11) of the first housing part (6),
(S20) Electrically connecting the electrode assembly (2) with at least one or a plurality of the said current conducting devices (4, 4a), in particular by means of a joining method, preferably by means of a friction welding method, particularly preferably by means of ultrasonic welding,
(S23) Bringing the second housing part (6a) to the first housing part (6), wherein the second housing part (6a) preferably has the second polymer material (21) in an edge section,
(S26) Connecting, in particular materially connecting the second housing part (6a) or the third housing part (6b) with the first housing part (6), in particular under the influence of heat, in particular at a working temperature that corresponds at least to the softening temperature of the second polymer material (21), wherein an edge section of the first housing part (6) is preferably connected with the second housing part (6a) or the third housing part (6b),
preferably with
(S25) Heating in particular the edge section of in particular the first housing part to a working temperature that corresponds at least to the softening temperature of the second polymer material,
wherein preferably instead of step S23 the following is executed:
(S24) Bringing the third housing part (6b) to the first housing part (6), wherein a first heat transfer section of the third housing part (6b) is preferably arranged adjacent to the electrode assembly (2), particularly preferably is brought into thermal contact with the electrode assembly (2),
wherein preferably instead of step S26 the following is executed:
(S26′) Connecting, in particular materially connecting, the second housing part or the third housing part with the first housing part, in particular with the deployment of a sealant or an adhesive, wherein an edge section of the first housing part is preferably connected with the second housing part or the third housing part, or
(S26″) Connecting, in particular materially connecting, the second housing part or the third housing part with the first housing part, preferably with the supply of a second polymer material, in particular one that is able to flow, preferably under the influence of heat and with a pressure differential with respect to the surroundings of the processing device, in particular into the moulding tool, wherein the second polymer material is arranged in the edge section of the at least one housing part, in particular at a temperature that corresponds at least to the softening temperature of the second polymer material, wherein in each of said contact sections at least one or two of said current conducting devices preferably remains free, wherein an edge section of the first housing part is preferably connected with the second housing part or the third housing part, in particular after step S25.

15. The method, in particular in accordance with claim 14, in particular for the manufacture of the converter cell (1), in particular for the manufacture of the first and/or second housing part (6, 6a), characterised by the steps:
(S11) Bringing the essentially planar moulding blank (23) into a processing device (20), in particular into a moulding tool,
(S12) Inserting at least one or a plurality of the said current conducting devices (4, 4a), preferably the insertion of at least one or a plurality of the said current collectors (14, 14a), into the processing device (20), in particular into the moulding tool, in particular to the essentially planar moulding blank (23),
(S14) Bringing a second polymer material (21), in particular one that is able to flow, preferably under the influence of heat and preferably with a pressure differential from the ambient air pressure, to the moulding blank (23), into the processing device (20), in particular into the moulding tool, wherein the second polymer material (21) is arranged in the edge section of the moulding blank (23), in particular at a working temperature that corresponds at least to the softening temperature of the second polymer material (21), wherein in each of the said contact sections (12, 12a) at least one or two of the said current conducting devices (14, 14a) preferably remains free,
(S15) Strengthening the deformed moulding blank (23), preferably by cooling down to an extraction temperature, which in particular lies below the softening temperature of the first polymer material, which in particular lies below the softening temperature of the second polymer material (21),
(S16) Extracting the in particular deformed moulding blank (23), hereinafter also referred to as the first housing part (6), from the processing device (21), in particular at an extraction temperature that lies below the softening temperature of the first polymer material,
preferably with at least one of the steps:
(S10) Heating of the essentially planar moulding blank (23), preferably up to a working temperature that corresponds at least to the softening temperature of the first polymer material of the first loadbearing element (7)), in particular in the processing device (21), and/or
(S13) Forming an accommodation space (11) for the electrode assembly (2) in the moulding blank, in particular in the processing device (20), in particular by means of deformation of the in particular heated moulding blank (23) with a body, wherein the accommodation space (11) is matched to the shape of the electrode assembly (2), which preferably corresponds essentially to the shape of the electrode assembly (2), which particularly preferably is created by closing the moulding tool.

16. The method, in particular in accordance with claim 14, in particular for the manufacture of a layered composite (18, 18a) for the first or second housing part (6, 6a), wherein the layered composite (18, 18a) has the first load-bearing element (7), at least one or a plurality of the said functional devices (8, 8a, 8b), and preferably the second load-bearing element (7b), characterised by the steps:
(S2) Preparing, preferably from a second stock holding, the first load-bearing element (7), which has a first polymer material, in particular one that is interpenetrated by fibres, which preferably has one or two of the said pole contact openings (15, 15a), wherein one or two of the said pole contact openings (15, 15a) is in each case adjacent to one of the said pole contact sections (16, 16a),
(S3) Placing at least one or a plurality of the said functional devices (8, 8a, 8b), or functional modules, preferably from the first stock holding, onto the first load-bearing element (7), or onto one of the said functional devices (8, 8a, 8b), wherein at least one populated circuit board, in particular one that is flexible, is preferably placed as a functional device (8, 8a, 8b) onto the first load-bearing element (7), wherein the circuit board particularly preferably has the functional elements (9, 9a, 9b, 9c) in accordance with the first preferred configuration of the functional device (8, 8a, 8b),
(S4) Connecting, in particular materially connecting, the first load-bearing element (7) with at least one of the said functional devices (8, 8a, 8b), preferably under the influence of heat, preferably by means of an isotactic or a continuous press (20), whereupon the layered composite (18, 18a) is formed,
preferably with at least one of the steps:
(S1) Creating at least one or a plurality of the said functional devices (8, 8a, 8b) with at least one or a plurality of the said functional elements (9, 9a, 9b, 9c), wherein at least one or two of the said functional elements (9, 9a, 9b, 9c) is preferably designed as an electrode connection section, or as a pole contact section (16, 16a), preferably the supply of at least one or a plurality of the said functional devices (8, 8a, 8b) to a first stock holding, or
(S1′) Creating at least one or a plurality of the said functional devices (8, 8a, 8b) with at least one or a plurality of the said functional elements (9, 9a, 9b, 9c), wherein at least one or two of the said functional elements (9, 9a, 9b, 9c) is preferably designed as an electrode connection section, or as a pole contact section (16, 16a), wherein into at least one of the said functional devices (8, 8a, 8b) is introduced: a foam; a voided structure; in particular a honeycomb structure; at least one void for a temperature-regulating medium; a filler with the ability to change its phase; and/or a chemically reactive filler, preferably the supply of at least one or a plurality of the said functional devices (8, 8a, 8b) to a first stock holding, or
(S1″) Creating at least one or a plurality of the said functional devices (8, 8a, 8b) with in each case at least one or a plurality of the said functional elements (9, 9a, 9b, 9c), wherein at least one or two of the said functional elements (9, 9a, 9b, 9c) is preferably designed as an electrode connection section, or as a pole contact section (16, 16a), wherein at least one or a plurality of the said functional devices (8, 8a, 8b) is manufactured with a first layered section (10) with a first wall thickness (thick) and a second layered section (10a) with a second wall thickness (thin), wherein the fraction formed by the second wall thickness divided by the first wall thickness has a predetermined value less than 1, particularly preferably the first layered section (10) has a lower density than the second layered section (10a), preferably the supply of at least one or a plurality of the said functional devices (8, 8a, 8b) to a first stock holding,
preferably with the steps:
(S5) Placing a second load-bearing element (7a) onto one of the said functional devices (8, 8a, 8b), wherein the second load-bearing element (7a) has a first polymer material, in particular one that is interpenetrated by fibres, preferably from a third stock holding, wherein the second load-bearing element (7a) preferably has one or two contact openings (17, 17a), and
(S6) Connecting the second load-bearing element (7a) with one of the said functional devices (8, 8a, 8b), in particular with the adjacent functional device, preferably under the influence of heat, preferably by means of an isotactic or a continuous press (20),
particularly preferably with the step:
(S27) Bringing together a plurality of the said functional elements (9, 9a) into one of the said functional devices (8, 8a, 8b), as a result of which in particular a functional module is formed.

17. The method, in particular in accordance with claim 14, in particular for purposes of closing the cell housing (5) around the electrode assembly (2), in particular for the manufacture of the first preferred development of the first preferred embodiment of the converter cell (1), characterised by the steps:
S11, wherein one of the said moulding blanks (23) is supplied to a processing device (20) with one of the said functional devices (8, 8a, 8b), wherein the said functional device (8, 8a, 8b) has at least one of the said electrode connection sections (9),
S12, wherein one or preferably two of the said current conducting devices (4, 4a), i.e. their current collectors (14, 14a) are brought to the said moulding blank (23 in the moulding tool (20) and are there arranged in the edge section of the moulding blank (23), i.e. of the imminent first housing part (6) preferably S22, wherein at least one of the said contact sections (12, 12a) of one of the said current conducting devices (4, 4a), i.e. one of the said current collectors (14, 14a), is electrically connected with at least one of the said electrode connection sections of the functional device (8, 8a, 8b),
S10, S13 and S14, wherein S10 is preferably executed ahead of S13 in time, and S13 is preferably executed simultaneously with S14, whereupon the moulding blank (23) receives an accommodation space (11) for the electrode assembly (2) and the second polymer material (21) is arranged in the edge section of the moulding blank (23) such that the inserted current conducting devices (4, 4a), i.e. their current collectors (14, 14a), are enclosed by the second polymer material (21), in particular in a gas-tight manner,
S15, whereupon the softened first polymer material of the first load-bearing element (7) regains strength and the resulting first housing part (6) can be extracted from the moulding tool (20),
S18, for purposes of equipping the electrode assembly (2) with at least one or a plurality of the said collector tabs (13), wherein the collector tabs (13) are connected with at least one of the said electrodes (3) of first polarity, or with at least one of the said electrodes (3a) of second polarity,
S17 and S19, whereby the electrode assembly (2) is supplied to the first housing part (6) prepared in the processing device (20), and is preferably arranged in the accommodation space (11) of the first housing part (6),
S21, wherein the said collector tabs (13), which are connected with the said electrodes (3) of first polarity, and the said collector tabs (13a), which are connected with the said electrodes (3a) of second polarity, are electrically connected with differing current collectors (14, 14a), in particular by means of a joining method,
S23, wherein the second housing part (6a) is inserted into the processing device (20) towards the first housing part (6) and towards the electrode assembly (2), wherein at least one of the said edge sections of the first housing part (6) and at least one of the said edge sections of the second housing part (6a) are arranged adjacent to one another,
preferably S25, wherein in particular the edge section of in particular the first housing part (6) is heated to a working temperature that corresponds at least to the softening temperature of the second polymer material (21),
S26, wherein in particular the edge sections, preferably the second polymer materials (21) of the first housing part (6) and the second housing part (6a) are connected to each other, in particular materially connected, in particular at a working temperature that corresponds at least to the softening temperature of the second polymer material (21).
